(19) United States
(12) Patent Application Publication
(10) Pub. No.: US 2026/0140240 A1
(43) Pub. Date: May 21, 2026

(54) LIGHT DETECTION AND RANGING (LIDAR) SYSTEM AND OPERATING METHOD THEREOF

(71) Applicant: SAMSUNG ELECTRONICS CO., LTD., Suwon-si (KR)

(72) Inventors: Sangyun Park, Suwon-si (KR); Jangwoo You, Suwon-si (KR); Jinwoo Choi, Suwon-si (KR); Byunghoon Ko, Suwon-si (KR); Sunil Kim, Suwon-si (KR)

(73) Assignee: SAMSUNG ELECTRONICS CO., LTD., Suwon-si (KR)

(21) Appl. No.: 19/397,311

(22) Filed: Nov. 21, 2025

(30) Foreign Application Priority Data
Nov. 21, 2024 (KR) 10-2024-0167750

(51) Int. Cl. G01S 7/4911; G01S 7/481; G01S 17/58

(52) U.S. Cl. CPC G01S 7/4911; G01S 7/4815; G01S 7/4816; G01S 17/58

(57) ABSTRACT

A light-detection and ranging (LiDAR) system includes a signal generator configured to generate a plurality of lights each having a different wavelength from each other, a transceiver including a transmitter configured to emit the plurality of lights as a transmission light and a receiver configured to receive a reception light obtained by reflection of the transmission light from a target object, an optical path separator in the transceiver and configured to separate an optical path of the transmission light from an optical path of the reception light, and a convex lens in the optical path separator.

### CROSS-REFERENCE TO RELATED APPLICATION

This application is based on and claims priority to Korean Patent Application No. 10-2024-0167750, filed on Nov. 21, 2024, in the Korean Intellectual Property Office, the disclosure of which is incorporated by reference herein in its entirety.

### BACKGROUND

### 1. Field

The disclosure relates to a light detection and ranging (LiDAR) system and an operating method of the LiDAR system.

### 2. Description of Related Art

Frequency Modulated Continuous Wave (FMCW) driving has advantages over direct Time of Flight (dToF) driving, such as the possibility to use a lower peak power light source, robustness to ambient noise, and better eye safety. In particular, as FMCW driving uses lower peak power compared to dToF driving, FMCW driving is more suitable for implementing a silicon photonics (Si-Ph)-based LiDAR which has difficulties in obtaining a high optical output.

Related art scan methods using Si-Ph include an optical phased array (OPA) method, a focal plane (switch) Array (FPA/FPSA) method, a dispersive grating method, and so on. Among these methods, the FPA method has advantages of low control complexity and excellent side mode suppression ratio (SMSR) characteristics, and for this reason, the FPA method is particularly suitable for use with the FMCW driving.

When implementing a Si-Ph-based LiDAR, high optical efficiency is required to measure a long-distance. For example, a general automotive LiDAR requires a detection distance of 200 m or more, and the lower the optical efficiency of the Si-Ph chip, the higher the required output of a source laser, which leads to an increased unit price and system complexity.

In particular, a FMCW type LiDAR requires a process of mixing a received signal with a transmitted signal to measure a beat frequency. However, in the case of Si-Ph chips, the optical path guiding for this mixing is implemented using a waveguide coupler (for example, an optical coupler), and thus, optical loss may occur.

In the related art FPA method, a Si-Ph chip is placed on a focal plane of an objective lens, the light emitted from a transmission grating coupler is reflected by a target object and returned to a transmission grating coupler, and thus, optical path separation is required to dislocate the received light to a path of a reception grating coupler.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

Provided are a light detection and ranging (LiDAR) system and an operating method of the LiDAR system capable of reducing optical loss by separating an optical path of transmission light from an optical path of reception light in a LiDAR system.

Additional aspects will be set forth in part in the description which follows and, in part, will be apparent from the description, or may be learned by practice of the presented embodiments of the disclosure.

According to an aspect of the disclosure, a light-detection and ranging (LiDAR) system may include a signal generator configured to generate a plurality of lights each having a different wavelength from each other, a transceiver including a transmitter configured to emit the plurality of lights as a transmission light and a receiver configured to receive a reception light obtained by reflection of the transmission light from a target object, an optical path separator in the transceiver and configured to separate an optical path of the transmission light from an optical path of the reception light, and a convex lens in the optical path separator.

The signal generator may include a light source configured to generate the plurality of lights, a multiplexer configured to simultaneously receive and multiplex the plurality of lights, and an optical modulator configured to modulate the plurality of lights.

The transmitter may be further configured to emit the transmission light with a plurality of pixels.

The transceiver may include a focal plane array in which the plurality of pixels are arranged in a matrix.

Each pixel of the plurality of pixels may include a first optical antenna configured to emit the transmission light into a free space, a second optical antenna configured to receive the reception light from the free space, an optical coupler configured to generate an output signal by mixing a local oscillator signal and the reception light, and a photoelectric converter configured to convert the output signal into a first electrical signal.

The photoelectric converter may include a balanced photodiode configured to convert an optical signal into a second electrical signal and a transimpedance amplifier configured to amplify an intensity of the second electrical signal.

The optical path separator may include a first birefringent plate configured to divide light incident on a first port into two lights having orthogonal polarization states during forward propagation and recombine, during reverse propagation, two incident lights at a third port that is located at a different position from the first port, a second birefringent plate configured to allow first incident light to pass through the second birefringent plate without a spatial change during the forward propagation and allow the first incident light to pass through a second path that is different from a first path of the forward propagation during the reverse propagation, a third birefringent plate configured to recombine two incident lights at a second port during the forward propagation and divide light incident on the second port into two lights having orthogonal polarization states during the reverse propagation, a first Faraday rotator configured to rotate second incident light by +45° and a second Faraday rotator configured to rotate third incident light by −45°, where the second incident light and the third incident light are separated from each other between the first birefringent plate and the second birefringent plate, and a third Faraday rotator configured to rotate fourth incident light by +45° and a fourth Faraday rotator configured to rotate fifth incident light by −45°, where the fourth incident light and the fifth incident light are separated from each other between the second birefringent plate and the third birefringent plate.

A distance between the first port and the third port may be proportional to a thickness of the second birefringent plate.

Each pixel of the plurality of pixels may include a third optical antenna configured to emit the transmission light into a free space, a fourth optical antenna and a fifth optical antenna separated from each other and configured to receive the reception light from the free space, a first optical coupler configured to generate a first output signal by mixing a first local oscillator signal with first reception light in the reception light, a second optical coupler configured to generate a second output signal by mixing a second local oscillator signal with second reception light in the reception light, and a photoelectric converter configured to convert the first output signal and the second output signal into electrical signals.

The optical path separator may include a fourth birefringent plate configured to divide light incident on a fourth port into two lights having orthogonal polarization states during forward propagation and allow, during reverse propagation, incident light to pass through a sixth port and a seventh port that are located at different positions from the fourth port, a fifth birefringent plate configured to recombine two incident lights at a fifth port during the forward propagation and divide light incident on the fifth port into two lights having orthogonal polarization states during the reverse propagation, a fifth Faraday rotator between the fourth birefringent plate and the fifth birefringent plate, the fifth Faraday rotator configured to rotate first incident light by +45° during the forward propagation and the reverse propagation, and a half-wave plate between the fifth Faraday rotator and the fifth birefringent plate, the half-wave plate configured to rotate second incident light by +45° during the forward propagation and rotate the second incident light by −45° during the reverse propagation.

Each pixel of the plurality of pixels may include an adder configured to synthesize the first output signal and the second output signal converted into the electrical signals.

Each pixel of the plurality of pixels may include a sixth optical antenna configured to emit the transmission light into a free space, a first optical diode configured to convert first mixed light generated by mixing the reception light with first reflected light into a first electrical signal, and a second optical diode configured to convert second mixed light generated by mixing the reception light with second reflected light into a second electrical signal.

The optical path separator may include a fourth birefringent plate configured to divide light incident on a fourth port into two lights having orthogonal polarization states during forward propagation and allow, during reverse propagation, incident light to pass through a sixth port and a seventh port that are located at different positions from the fourth port, a fifth birefringent plate configured to recombine two incident lights at a fifth port during the forward propagation and divide light incident on the fifth port into two lights having orthogonal polarization states during the reverse propagation, a fifth Faraday rotator between the fourth birefringent plate and the fifth birefringent plate, the fifth Faraday rotator configured to rotate first incident light by +45° during the forward propagation and the reverse propagation, and a half-wave plate between the fifth Faraday rotator and the fifth birefringent plate, the half-wave plate configured to rotate second incident light by +45° during the forward propagation and rotate the second incident light by −45° during the reverse propagation, and wherein a surface of the fifth birefringent plate which faces the half-wave plate may include a partial reflection surface.

Each pixel of the plurality of pixels may include an adder configured to synthesize the first output signal and the second output signal that are converted into the first electrical signal and the second electrical signal, respectively.

The transmission light may have substantially equal ratios of a vertical polarization component and a horizontal polarization component.

Each pixel of the plurality of pixels may include a sixth optical antenna configured to emit the transmission light into a free space, and a photoelectric converter including a photodiode area configured to convert, into electrical signals, first mixed light generated by mixing the reception light with first reflected light, and second mixed light generated by mixing the reception light with second reflected light.

The optical path separator may include a fourth birefringent plate configured to divide light incident on a fourth port into two lights having orthogonal polarization states during forward propagation and allow, during reverse propagation, incident light to pass through a sixth port and a seventh port that are located at different positions from the fourth port, a fifth birefringent plate configured to recombine two incident lights at a fifth port during the forward propagation and divide light incident on the fifth port into two lights having orthogonal polarization states during the reverse propagation, a fifth Faraday rotator between the fourth birefringent plate and the fifth birefringent plate, the fifth Faraday rotator configured to rotate first incident light by +45° during the forward propagation and the reverse propagation, and a half-wave plate between the fifth Faraday rotator and the fifth birefringent plate, the half-wave plate configured to rotate second incident light by +45° during the forward propagation and rotate the second incident light by −45° during the reverse propagation, and a surface of the fifth birefringent plate which faces the half-wave plate may include a partial reflection surface.

According to an aspect of the disclosure, an operating method of a LiDAR system may include generating, by a signal generator, a plurality of lights each having a different wavelength from each other, emitting, by a transceiver, the plurality of lights as transmission light and receiving reception light obtained by reflection of the transmission light from a target object, and separating an optical path of the transmission light from an optical path of the reception light by an optical path separator in the transceiver.

The transceiver may include a focal plane array in which a plurality of pixels are arranged in a matrix, and where each pixel of the plurality of pixels may include an optical antenna configured to emit the transmission light into a free space, and a photoelectric converter including a photodiode area configured to convert, into electrical signals, first mixed light generated by mixing the reception light with first reflected light, and second mixed light generated by mixing the reception light with second reflected light.

The optical path separator may include a first birefringent plate configured to divide light incident on a first port into two lights having orthogonal polarization states during forward propagation and allow, during reverse propagation, incident light to pass through a third port and a fourth port that are located at different positions from the first port, a second birefringent plate configured to recombine two incident lights at a second port during the forward propagation and divide light incident on the second port into two lights having orthogonal polarization states during the reverse propagation, a first Faraday rotator arranged the first birefringent plate and the second birefringent plate, the first Faraday rotator configured to rotate first incident light by +45° during the forward propagation and the reverse propagation, and a half-wave plate between the first Faraday rotator and the second birefringent plate, the half-wave plate configured to rotate second incident light by +45° during the forward propagation and rotate the second incident light by −45° during the reverse propagation, and where a surface of the second birefringent plate which faces the half-wave plate may include a partial reflection surface.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a diagram illustrating a transmission signal transmitted by a frequency modulated continuous wave (FMCW) light detection and ranging (LiDAR) system, a reception signal obtained by reflection of the transmission signal from a target object, and a beat frequency according to one or more embodiments;

FIG. 2 is a diagram illustrating a LiDAR system according to one or more embodiments;

FIG. 3A is a block diagram illustrating a light source applicable to a signal generator, according to one or more embodiments;

FIG. 3B is a block diagram illustrating a light source applicable to a signal generator, according to one or more embodiments;

FIG. 3C is a block diagram illustrating a light source applicable to a signal generator, according to one or more embodiments;

FIG. 3D is a block diagram illustrating a light source applicable to a signal generator, according to one or more embodiments;

FIG. 4 is a diagram illustrating a pixel included in a focal plane array according to one or more embodiments;

FIG. 5 is a block diagram illustrating a circuit according to one or more embodiments;

FIG. 6 is a diagram illustrating a driving method of a LiDAR system, according to one or more embodiments;

FIG. 7A is a diagram illustrating an operation of a micro-electromechanical system (MEMS) according to one or more embodiments;

FIG. 7B is a diagram illustrating an operation of a micro ring resonator according to one or more embodiments;

FIG. 8A is a diagram illustrating optical loss of the pixel structure illustrated in FIG. 4 according to one or more embodiments;

FIG. 8B is a diagram illustrating optical loss of the pixel structure illustrated in FIG. 6 according to one or more embodiments;

FIG. 8C and FIG. 8D are diagrams illustrating structures for supplementing the pixels illustrated in FIG. 8A and FIG. 8B according to one or more embodiments;

FIG. 9A is a block diagram illustrating a configuration of a LiDAR system according to one or more embodiments;

FIG. 9B is a block diagram illustrating a configuration included in an optical path separator according to one or more embodiments;

FIG. 10A is a diagram illustrating an optical path separator viewed from a pixel according to one or more embodiments;

FIG. 10B is a perspective view illustrating an optical path dislocation of a reception signal by an optical path separator, according to one or more embodiments;

FIG. 10C is a diagram illustrating a process of forming the optical path separator illustrated in FIG. 10B according to one or more embodiments;

FIG. 11 is a perspective view illustrating an optical path separator according to one or more embodiments;

FIG. 12A is a diagram illustrating an optical path separator from a pixel side according to one or more embodiments;

FIG. 12B is a perspective view illustrating an optical path dislocation of a signal received by the optical path separator of FIG. 12A according to one or more embodiments;

FIG. 13A is a diagram illustrating an optical path separator from a pixel side according to one or more embodiments;

FIG. 13B is a perspective view illustrating a partial reflective surface included in the optical path separator of FIG. 13A according to one or more embodiments;

FIG. 13C is a diagram illustrating a photodiode of FIG. 13A according to one or more embodiments;

FIG. 14 is a flowchart illustrating an operating method of a LiDAR system, according to one or more embodiments;

FIG. 15 is a perspective view illustrating an example of an electronic device to which a LiDAR system according to one or more embodiments is applied; and

FIG. 16 and FIG. 17 are respectively a side view and a plan view conceptually illustrating cases where a LiDAR system according to one or more embodiments is applied to a vehicle.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

The terms used in the embodiments are selected from the most widely used general terms while considering functions in the embodiments, and the terms may change depending on intentions of engineers engaged in the relevant technical field, precedents, the emergence of new technologies, and so on. Also, there are terms randomly selected in a certain case, and in this case, meanings thereof are described in detail in the relevant embodiments. Therefore, the terms used in the embodiments should be defined based on meanings of the terms and the overall descriptions of the embodiments, not simply the names of the terms.

In describing the embodiments, when it is said that a component is connected to another component, this includes not only a case where the component is directly connected thereto, but also a case where the component is electrically connected thereto with another component therebetween. Also, when a portion “includes” a certain component, this may indicate that other components may be further included rather than excluding other components unless specifically stated to the contrary.

The terms “configured/composed”, “comprise/include”, or so on used in the embodiments should not be interpreted as including all of the various components or various steps/operations described in the embodiments, and some of the components or some of the steps may not be included therein, or additional components or steps may be included therein.

The descriptions of the following embodiments should not be interpreted as limiting the scope of the rights, and what may be easily inferred by a person skilled in the art should be interpreted as falling within the scope of the rights of the embodiments. The following embodiments are described in detail solely for the purpose of illustration with reference to the attached drawings.

Terms such as first, second, etc. may be used to describe various components, but are used only for the purpose of distinguishing one component from another component. These terms do not limit the difference in the material or structure of the components.

The terms of a singular form may include plural forms unless otherwise specified. The use of the term “the” and similar designating terms may correspond to both the singular and the plural. Operations of a method may be performed in an appropriate order unless explicitly described in terms of order. In addition, the use of all illustrative terms (e.g., etc.) is merely for describing technical ideas in detail, and the scope is not limited by these examples or illustrative terms unless limited by the claims.

A general frequency modulated continuous wave (FMCW) light detection and ranging (LiDAR) system may transmit a frequency modulation signal in the form of a triangular wave from the viewpoint of frequency versus time.

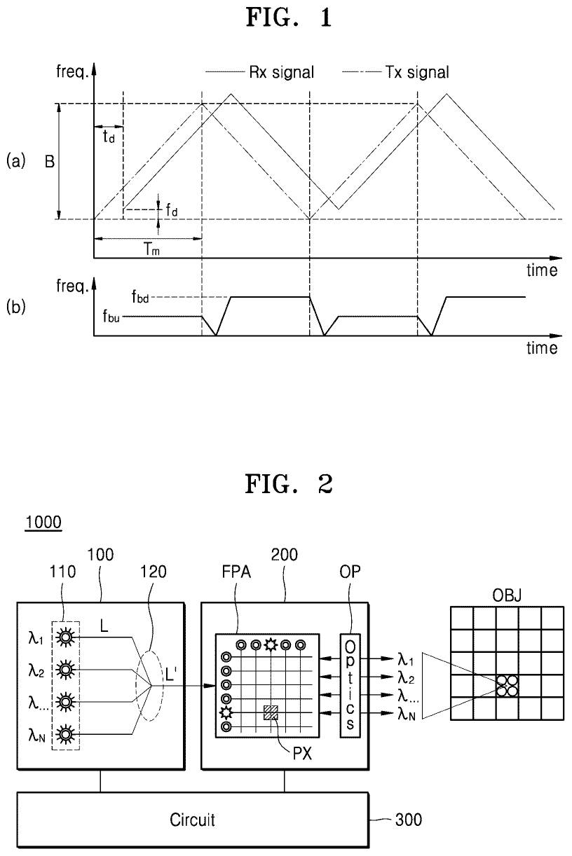

FIG. 1 is a diagram illustrating a transmission signal transmitted by an FMCW LiDAR system, a reception signal obtained by reflection of the transmission signal from a target object, and a beat frequency according to one or more embodiments.

In FIG. 1, (a) illustrates a transmission signal transmitted by an FMCW LiDAR and a reception signal obtained by reflection of the transmission signal from a target object. The transmission signal indicated by a dotted line and the reception signal indicated by a solid line have a time difference of a delay time td therebetween and a frequency difference of a Doppler frequency fd therebetween. Here, B represents a modulation bandwidth, and Tm represents a modulation period.

In FIG. 1, (b) illustrates the beat frequency expressed as a frequency difference between the transmission signal and the reception signal. Also, fbu indicates an up-beat frequency corresponding to up chirp, and fbd indicates a down-beat frequency corresponding to down chirp.

The up-beat frequency and the down-beat frequency include frequency shift components caused by a distance to a moving object and a relative speed. These are respectively referred to as the beat frequency fb and the Doppler frequency fd.

The up-beat frequency fbu and the down-beat frequency fbd may be respectively expressed via Equation 1 and Equation 2 below.

$$Fbu = fb - fd \qquad ( 1 )$$

$$fbd = fb + fd \qquad ( 2 )$$

A Doppler frequency of a positive value indicates that a moving object approaches a LiDAR, and a Doppler frequency of a negative value indicates that the moving object is moving away from the LiDAR. Therefore, a distance between the moving object and the LiDAR may be an average of the up-beat frequency fbu and the down-beat frequency fbd, and a moving speed of the moving object may be determined by using the Doppler frequency fd. The up-beat frequency fbu and the down-beat frequency fbd may be obtained by performing a fast Fourier transform (FFT) on the received beat signal.

FIG. 2 is a diagram illustrating a LiDAR system according to one or more embodiments.

Referring to FIG. 2, a LiDAR system 1000 may include a signal generator 100, a transceiver 200, and a circuit 300. The signal generator 100, the transceiver 200, and the circuit 300 may be configured in a chip (or a semiconductor optical device). For example, the chip may be a silicon photonics (Si-Ph) chip.

According to one or more embodiments, the signal generator 100 may include a light source 110 and an optical coupler 120.

The light source 110 may generate multiple lights L having different wavelengths. The multiple lights L may be referred to as multi-wavelength (multi-A) electromagnetic waves. For example, the multiple lights L may be multiple lasers having different wavelengths, but may also be other lights instead of the lasers. The light source 110 may generate the multiple lights L simultaneously.

The optical coupler 120 may simultaneously receive multiple lights L emitted from the light source 110 and output multiplexed lights L′.

Although not illustrated in FIG. 2, the light source 110 may further include an optical modulator for modulating the multiple lights.

For FMCW driving, an optical modulator (or the signal generator 100) may perform frequency modulation (or chirping) on lights having wavelengths (for example, λ₁, λ₂, . . . , λ_{N}) as illustrated in FIG. 1. In this case, a bandwidth of the frequency modulation (or chirping) determines a depth resolution. For example, for a depth resolution of 10 cm, a frequency modulation (or chirping) has to be performed with a bandwidth of about 1.5 GHz. The frequency modulation (or chirping) may be performed through open-loop control or closed-loop control, and may be made by pre-distortion based on information obtained through pre-calibration to improve linearity characteristics. In one or more embodiments, intervals between the multiple wavelengths λ₁, λ₂, . . . , λ_{N} may be wider than a bandwidth of the frequency modulation for FMCW driving from the viewpoint of crosstalk limitation.

An optical modulator may modulate light in various ways. For example, the optical modulator may modulate the phase of light. Alternatively, the optical modulator may modulate the amplitude of light. Alternatively, the optical modulator may simultaneously modulate the phase and amplitude of light. In addition, an optical modulation function of the optical modulator may be changed in various ways. In addition, the optical modulator may perform optical modulation by using an electrical method or may perform the optical modulation by various methods, such as a magnetic method, a thermal method, and a mechanical method. For example, the optical modulator may include at least one phase shifter or phase shifting element, and the phase shifter may include at least one or multiple elements selected from, for example, a gain element, an all-pass filter, a Bragg grating, a dispersive material element, a wavelength tuning element, and a phase tuning element. Also, an actuation mechanism applied to the optical modulator may include at least one selected from, for example, thermo-optic actuation, electro-optic actuation, electro-absorption actuation, free carrier absorption actuation, magneto-optic actuation, liquid crystal actuation, and all-optical actuation. The actuation mechanism may be related to the phase tuning described above. However, the configuration and actuation mechanism of the phase shifter specifically described herein are examples, and the embodiments are not limited thereto.

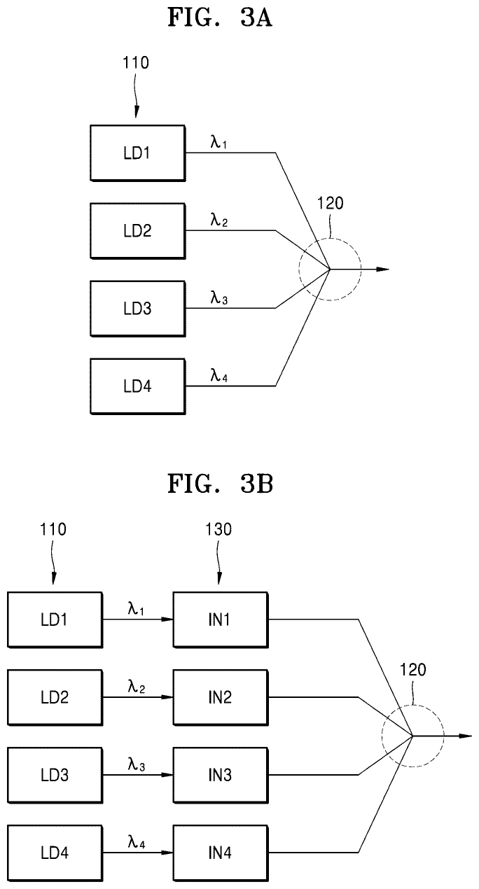

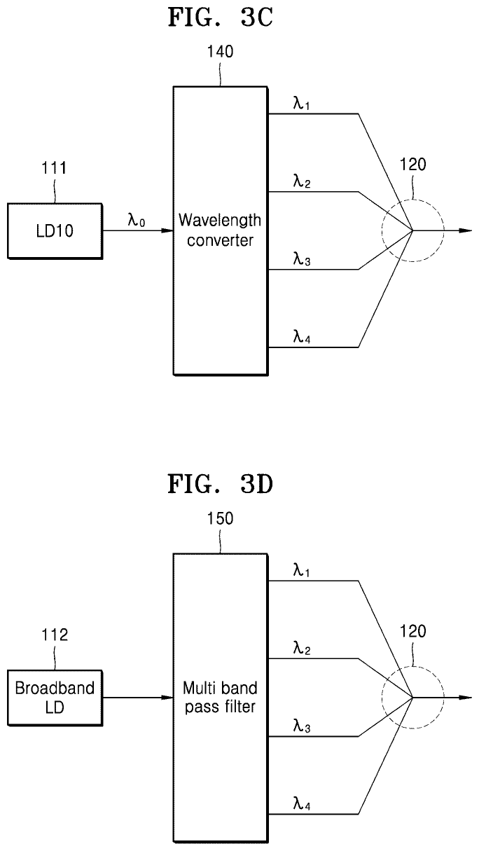

Specific configurations of the light source 110 are described in detail below with reference to FIG. 3A to FIG. 3D.

According to one or more embodiments, the transceiver 200 may include a focal plane array FPA in which multiple pixels PX (or pixel groups) are arranged in a matrix, and an optical element OP for controlling a light emission angle.

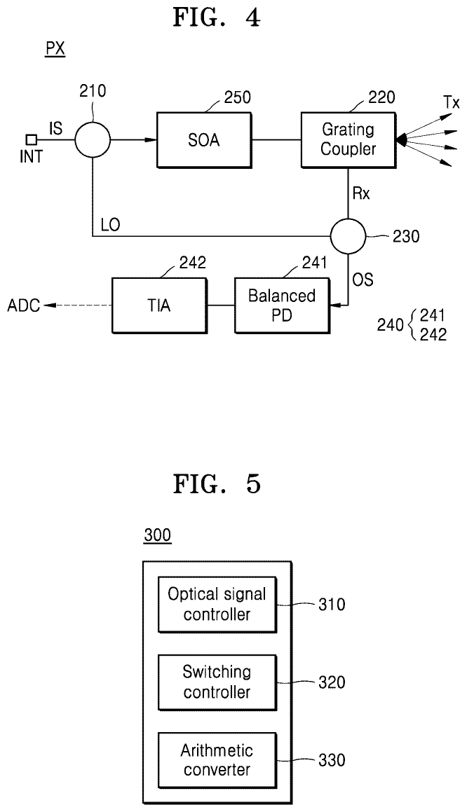

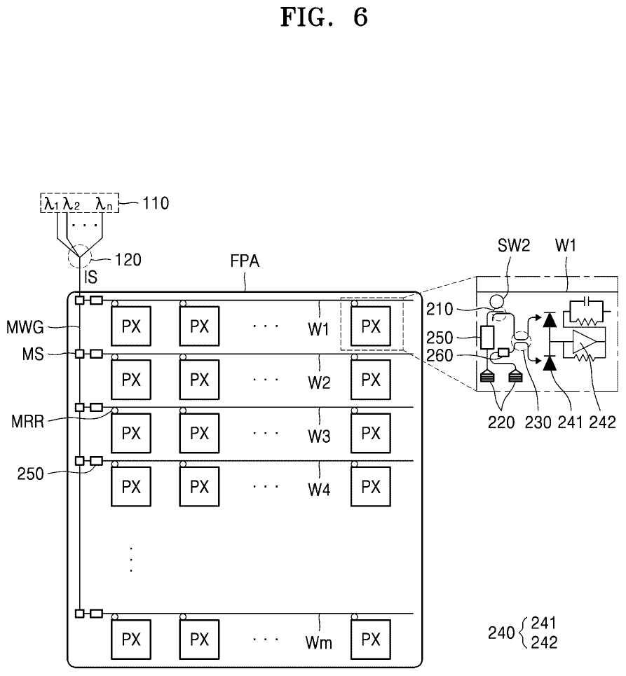

The transceiver 200 may be functionally divided into a transmitter and a receiver. The transmitter may correspond to an optical antenna 220 and an optical amplifier 250 of FIG. 4 described below and a first optical switch SW1 and a second optical switch SW2 of FIG. 6 described below, and the receiver may correspond to a second optical coupler 230, a balanced photodiode 241, and a transimpedance amplifier 242 of FIG. 4 described below.

The transmitter may have at least one axis of x-y axes implemented as a focal plane array FPA type. Also, in the transmitter, one pixel PX included in the focal plane array FPA may simultaneously or sequentially emit multiple multiplexed lights L′ as a transmission signal.

According to one or more embodiments, when the multiple multiplexed lights L′ are emitted from the pixel PX to a free space, the multiple multiplexed lights L′ may be controlled to have different emission angles depending on wavelengths. For example, the optical element OP may include a prism, a micro-prism array, a diffraction grating, or so on.

The receiver may mix a transmission signal with a reception signal obtained by reflection of the transmission signal from a target object OBJ and convert the mixed signal into an electrical signal. For example, the receiver may perform 50:50 coupling on the received signal by using the second optical coupler 230 of FIG. 4 described below, and then, the coupled signal is input to the balanced photodiode 241. However, a coupling method of the receive is not limited thereto, and may also be performed by using, for example, a beam splitter or so on. Regardless of a specific mixing method, the signal obtained by the receiver may include tone frequency information on lights having respective wavelengths. The lights having respective wavelengths include distance and/or speed information on the target object OBJ, which is reflected in a tone frequency.

The circuit 300 is connected to the signal generator 100 and the transceiver 200, and may control operations of the signal generator 100 and the transceiver 200. For example, the circuit 300 may analyze the frequency of an electrical signal obtained by the transceiver 200 (or the receiver) and convert the frequency into distance and/or speed information of the target object OBJ. A specific configuration of the circuit 300 is described in detail below with reference to FIG. 5.

Hereinafter, a configuration of the light source 110 is described in more detail with reference to FIG. 3A to FIG. 3D.

FIG. 3A is a block diagram illustrating a light source that may be applied to a signal generator according to one or more embodiments.

According to one or more embodiments, the light source 110 may include multiple laser sources LD1 to LD4 as illustrated in FIG. 3A. Although FIG. 3A illustrates four laser sources LD1 to LD4, the number of the laser sources LD1 to LD4 may vary. The multiple laser sources LD1 to LD4 may be, for example, laser diodes. The multiple laser sources LD1 to LD4 may generate lasers having different wavelengths (for example, λ₁, λ₂, λ₃, and λ₄). The lasers having different wavelengths λ₁, Δ₂, λ₃, and λ₄ generated by the multiple laser sources LD1 to LD4 may be input to the optical coupler 120 and multiplexed.

FIG. 3B is a block diagram illustrating a light source that may be applied to a signal generator according to one or more embodiments.

Referring to FIG. 3B, lasers having different wavelengths λ₁, λ₂, λ₃, and λ₄ generated by multiple laser sources LD1 to LD4 may be respectively input to multiple input couplers IN1 to IN4. The multiple input couplers IN1 to IN4 may be included in the input unit 130. The multiple input couplers IN1 to IN4 may each have, for example, an optical fiber structure or another configuration. Multiple lights passing through the multiple input couplers IN1 to IN4 may be multiplexed by the optical coupler 120.

In FIG. 3B, the multiple input couplers IN1 to IN4 and the optical coupler 120 may be connected to a predetermined optical waveguide. In some cases, the multiple input couplers IN1 to IN4 and the optical coupler 120 may also be combined to form an input unit.

FIG. 3C is a block diagram illustrating a light source that may be applied to a signal generator according to one or more embodiments.

Referring to FIG. 3C, a light source 111 may include a laser source LD10 that generates a laser having a single wavelength λ₀. That is, the light source 111 may include the single laser source LD10. A wavelength converter 140, which divides the laser generated by the laser source LD10 into multiple lasers having different wavelengths (for example, λ₁, λ₂, λ₃, and λ₄), may be further provided. For example, the wavelength converter 140 may include an input coupler, an optical splitter, and multiple wavelength conversion elements. The laser input to the input coupler may be split by the optical splitter, and then, a wavelength of the laser may be converted by the multiple wavelength conversion elements. As a result, the multiple lights having different wavelengths (for example, λ₁, λ₂, λ₃, and λ₄) may be output through the wavelength converter 140. The multiple lights may be multiplexed by the optical coupler 120.

In FIG. 3C, the laser source LD10 and the wavelength converter 140 may be combined to form a light source. The light source may generate multiple lights having different wavelengths (for example, λ₁, λ₂, λ₃, and λ₄). Also, at least part of the wavelength converter 140 or at least part of the optical coupler 120 may be referred to as an input coupler. Alternatively, the wavelength converter 140 and the optical coupler 120 may be combined to form an input coupler.

FIG. 3D is a block diagram illustrating a light source that may be applied to a signal generator according to one or more embodiments.

Referring to FIG. 3D, a light source 112 may include a broadband laser. That is, the broadband laser may be a device that generates light of a wideband. A multi-band pass filter 150 for dividing the light generated by the light source 112 may be provided. Lights having multiple wavelengths (for example, λ₁, λ₂, λ₃, and λ₄) that are distinguished from each other may be output through the multi-band pass filter 150. The lights may be multiplexed by the optical coupler 120.

In FIG. 3D, a broadband laser and the multi-band pass filter 150 may be combined to form one light source. The light source may generate multiple lights having different wavelengths. In the embodiment, the optical coupler 120 may be referred to as an “input coupler”.

FIG. 4 is a diagram illustrating a pixel included in a focal plane array according to one or more embodiments.

Referring to FIG. 4, a pixel PX may divide an input signal IS into a local oscillator signal LO and a transmission signal Tx, couple the transmission signal Tx to a free space, couple a reception signal Rx back to the pixel PX, and mix the local oscillator signal LO with the reception signal Rx.

According to one or more embodiments, the pixel PX may include a first optical coupler 210, the optical antenna 220, the second optical coupler 230, and a photoelectric converter 240. The pixel PX may receive multiple multiplexed lights (see L′ of FIG. 2) as the input signal IS. The first optical coupler 210 may be provided between an input terminal INT and the optical antenna 220. The first optical coupler 210 may divide the input signal IS received at the input terminal INT into the local oscillator signal LO and the transmission signal Tx. The optical antenna 220 may receive the reception signal Rx reflected from a target object.

The optical antenna 220 emits the light from an on-chip waveguide into a free space and/or couples the light from a free space to the on-chip waveguide. The optical antenna 220 may be implemented by a grating coupler, an edge coupler, an integrated reflector, or a random spot size converter. The optical antenna 220 may be sensitive to polarization with higher emission/coupling efficiency for the light having a certain polarization (for example, transverse electric (TE) or transverse magnetic (TM)). The optical antenna 220 may be reciprocal, thereby collecting the reception signal Rx from a measurement target object (for example, an object in the environment). The optical antenna 220 may provide the reception signal Rx to the second optical coupler 230. Although FIG. 4 illustrates a co-axial implementation method in which light emission and collection are performed through the same optical antenna 220, the disclosure is not limited thereto, and for example, a bi-axial implementation method may also be used in which light emission and collection are performed separately by using different optical antennas as illustrated in FIG. 6.

The second optical coupler 230 may mix the reception signal Rx with the local oscillator signal LO provided by the first optical coupler 210 to generate an output signal OS. The second optical coupler 230 may be a balanced 2×2 optical mixer.

The pixel PX may include the photoelectric converter 240 that converts the output signal OS, which is an optical signal, into an electrical signal. The photoelectric converter 240 may include the balanced photodiode 241 configured to convert an optical signal into an electrical signal to detect a tone frequency, and the transimpedance amplifier (TIA) 242 that amplifies the intensity of an electrical signal generated by the balanced photodiode 241. For example, the transimpedance amplifier 242 may amplify a current generated by the balanced photodiode 241 and convert the current into voltage. An electrical signal output from the transimpedance amplifier 242 may be provided to an analog-to-digital converter (ADC) (or a circuit (see 300 of FIG. 5)).

The pixel PX according to one or more embodiments may further include the optical amplifier 250 provided between the first optical coupler 210 and the optical antenna 220 to compensate for optical loss. For example, the optical amplifier 250 may be a semiconductor optical amplifier (SOA) and may amplify an optical signal such that the light generated by the light source (see 110 of FIG. 2) may maintain the preset intensity even in the optical antenna 220. Alternatively, the optical amplifier 250 may increase a signal-to-noise ratio (SNR).

FIG. 5 is a block diagram illustrating a circuit according to one or more embodiments.

Referring to FIG. 5, the circuit 300 may include an optical signal controller 310, a switching controller 320, and an arithmetic unit 330.

The optical signal controller 310 may control a frequency modulation (or chirping) of the signal generator 100 described above, which may include a feedback circuit, such as a phase-locked loop (PLL).

The switching controller 320 may control the switching of a focal plane array FPA of at least one axis of a transmitter of the transceiver 200. In this case, the switching control may be the manipulation of an optical micro-electromechanical system (MEMS) component. Also, the switching control may be a heating (or thermal) control for a thermo-optical element that manipulates a phase of, for example, a micro ring resonator, a mach-zender interferometer (MZI), or so on. Also, the switching control may be a control for electro-optical modulation according to a carrier concentration adjustment.

The arithmetic converter 330 may analyze the frequency of an electrical signal obtained from a receiver of the transceiver 200 and convert the analyzed information into information on a distance to and/or a speed of a target object. For example, an analog electrical signal may be binarized by an analog-to-digital converter, fast-Fourier-transformed by a digital arithmetic converter, and converted into frequency domain information. The frequency domain information of each pixel may be converted into a point cloud representing a depth or velocity map and may be utilized in a high-level application, such as autonomous driving, through an analysis algorithm including image processing.

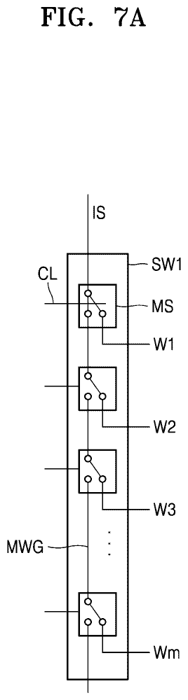

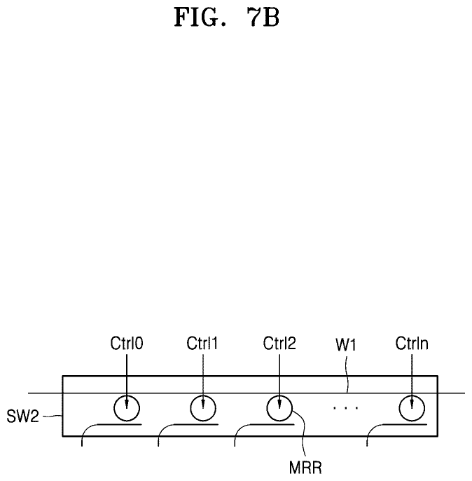

FIG. 6 is a diagram illustrating a driving method of a LiDAR system according to one or more embodiments. FIG. 7A is a diagram illustrating an operation of a MEMS switch according to one or more embodiments. FIG. 7B is a diagram illustrating an operation of a micro ring resonator according to one or more embodiments.

Referring to FIG. 2, FIG. 4, FIG. 6, and FIG. 7A, in the LiDAR system 1000 according to one or more embodiments, one pixel PX included in the focal plane array FPA may simultaneously emit multiple multiplexed lights L′ as the transmission signal Tx and receive the reception signal Rx obtained by reflection of the transmission signal Tx from a target object. In this case, the transmission signal Tx may be a signal obtained by excluding the local oscillator signal LO among the multiple multiplexed lights L′.

Specifically, multiple lights L having different wavelengths generated by the light source 110 may be converted into the multiplexed light L′ through the optical coupler 120. The multiplexed light L′ may be provided to the focal plane array FPA through a main bus waveguide MWG.

When the first optical switch SW1 turns on, the first optical switch SW1 may selectively transmit the light of the main bus waveguide MWG to row waveguides W1 to Wm. The first optical switch SW1 may be implemented by not only an optical MEMS switch but also another component, and may be a wideband switch that may simultaneously turn on/off a wide frequency range over λ₁ to λₙ. Therefore, an MZI switch or so on may also be utilized therefor.

Referring to FIG. 7A, the first optical switch SW1 may be implemented by an array of multiple MEMS switches MS. Respective MEMS switch MS may steer the optical input signal IS from the main bus waveguide MWG respectively according to control signals provided respectively through corresponding control lines CL, and may selectively provide the optical input signal IS to multiple row waveguides W1 to Wm.

Referring again to FIG. 2, FIG. 4, and FIG. 6, when the second optical switch SW2 turns on, the second optical switch SW2 may selectively transmit the lights from the row waveguides W1 to Wm selected by the first optical switch SW1 to the pixels PX. Although the second optical switch SW2 is illustrated as a micro ring resonator, the disclosure is not limited thereto, and the second optical switch SW2 may be implemented by a switch capable of sequentially or simultaneously turning on/off to transmit the lights having multiple wavelengths λ₁ to λₙ depending on driving methods. When the second optical switch SW1 turns on, light may be emitted to a free space through the optical antenna 220.

Referring to FIG. 7B, the second optical switch SW2 may be implemented by an array of micro ring resonators MRR. When the resonance frequency of a device is aligned with a laser wavelength, respective micro ring resonators MRR may respectively pick up optical signals from row waveguides (for example, W1 to Wm of FIG. 7A). According to one or more embodiments, electrical control signals (for example, Ctrl0, Ctrl1, Ctrl2, . . . , Ctrln) may be used to set resonances of the respective micro ring resonators MRR in the array, thereby selecting the pixel PX for receiving an optical signal.

Referring again to FIG. 2, FIG. 4, and FIG. 6, the transceiver 200 (or the focal plane array FPA) may further include an optical amplifier 250 to compensate for optical attenuation and loss. The optical amplifier 250 may be provided between the first optical switch SW1 and the second optical switch SW2 on each of the row waveguides W1 to Wm. Also, the optical amplifier 250 may be provided between the second optical switch SW2 and the optical antenna 220 within the pixel PX. For example, the optical amplifier 250 may be a semiconductor optical amplifier (SOA) and may amplify an optical signal such that the light generated by the light source 110 may maintain the intensity in the optical antenna 220. Alternatively, the optical amplifier 250 may also increase a signal-to-noise ratio (SNR).

When a certain pixel PX is activated by the first optical switch SW1 and the second optical switch SW2, the light transmitted through a waveguide may be emitted to a free space through the optical antenna 220. In this case, the optical antenna 220 may be a grating coupler. The lights having different wavelengths λ₁ to λₙ may have different emission angles by a grating coupler and/or an optical element (OP in FIG. 2).

The light collected by being reflected by a target object may be transmitted to a waveguide through the optical antenna 220. A part (or the transmission signal Tx) of the light transmitted to the optical antenna 220 may be mixed with the reception signal Rx by the second optical coupler 230, and a beating optical signal may be transmitted to the photoelectric converter 240. The photoelectric converter 240 may convert beat frequency information into an electrical signal. The photoelectric converter 240 may include the balanced photodiode 241 and the transimpedance amplifier 242. However, the disclosure is not limited thereto, and the photoelectric converter 240 may be appropriately implemented by, for example, an avalanche photodiode, a single-photon avalanche diode, or so on. The photoelectric converter 240 may further include a low-pass filter or a band-pass filter to exclude high-frequency components from the mixed signal and leave only meaningful bit frequencies.

In addition, when the pixel PX simultaneously emits or receives lights having various wavelengths, a circuit (see 300 of FIG. 2) (or the arithmetic unit 330 of FIG. 5) has to be able to separate and process pieces of information of respective wavelengths, and accordingly, in the pixel PX, a waveguide in front of the second optical coupler 230 may include a demultiplexer 260 for wavelengths. For example, the demultiplexer 260 may be implemented by an optical band-pass filter, a micro ring resonator, or so on. Although FIG. 6 illustrates only an example in which the demultiplexer 260 is provided in a waveguide between the optical antenna 220 and the second optical coupler 230, but the disclosure is not limited thereto.

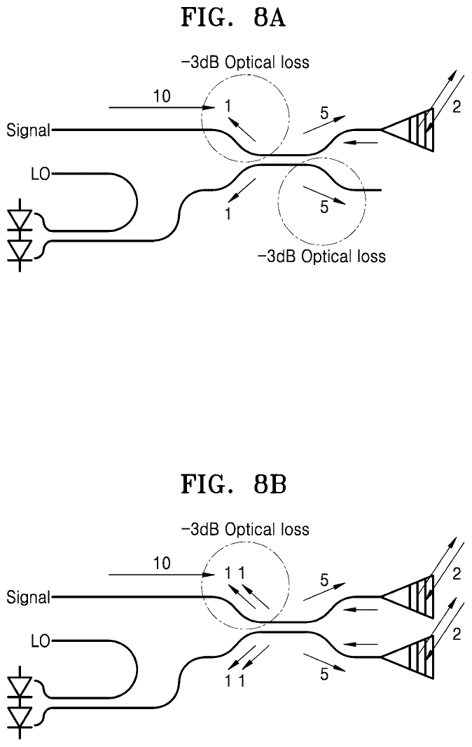

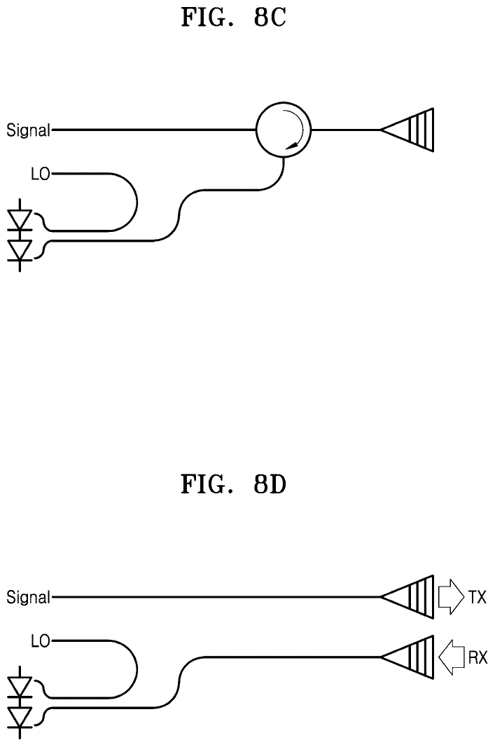

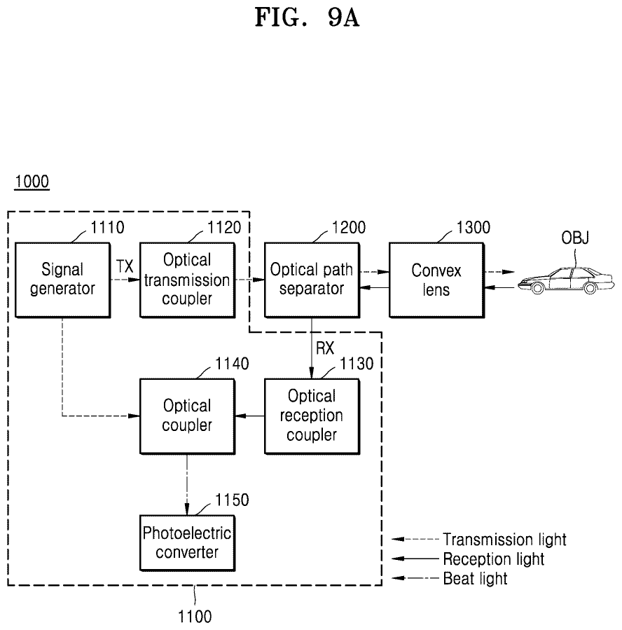

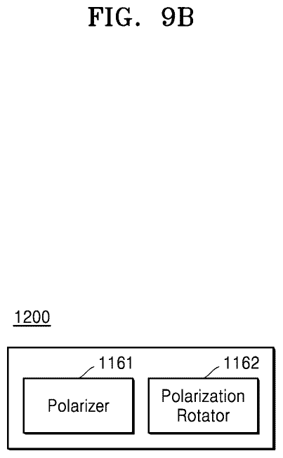

FIG. 8A is a diagram illustrating optical loss of the pixel PX illustrated in FIG. 4 according to one or more embodiments. FIG. 8B is a diagram illustrating optical loss of the pixel PX illustrated in FIG. 6 according to one or more embodiments. FIG. 8C and FIG. 8D are diagrams illustrating a structure for supplementing the pixel PX illustrated in FIG. 8A and FIG. 8B according to one or more embodiments.

Referring to FIG. 8A, the pixel PX illustrated in FIG. 8A may emit and collect lights by using a single grating coupler (for example, the optical antenna 220 of FIG. 4). In the pixel PX illustrated in FIG. 8A, optical loss of 3 dB due to 50:50 coupling occurs twice consecutively during light emission and light reception, resulting in optical loss of 6 dB.

In addition, referring to FIG. 8B, the pixel PX illustrated in FIG. 8B may include two grating couplers (for example, the optical antennas 220 of FIG. 6) in which emission and collection of lights are performed separately. In the pixel PX illustrated in FIG. 8B, the optical loss of 3 dB due to 50:50 coupling occurs only during light reception and does not occur during light emission, and thus, optical efficiency may be improved compared to the pixel PX illustrated in FIG. 8A in which optical loss of 6 dB occurs.

Although the optical efficiency of the pixel PX illustrated in FIG. 8B is improved compared to the pixel PX illustrated in FIG. 8A, the optical loss of 3 dB still occurs. The optical loss of 3 dB accounts for 10% to 25% of the entire optical efficiency of a Si-Ph chip, and accordingly, there is still a need for improvement.

Referring to FIG. 8C and FIG. 8D, the pixel PX illustrated in FIG. 8C includes an optical circulator instead of the optical coupler. When the optical circulator is used, optical loss may not occur ideally. However, it is realistically difficult to implement the optical circulator on the Si-Ph chip, and accordingly, by providing two grating couplers only for the transmission signal Tx and the reception signal Rx as in the pixel illustrated in FIG. 8D, optical loss may be reduced. In the general FPA method, the Si-Ph chip is on a focal plane of an objective lens, and accordingly, the light emitted from a grating coupler for the transmission signal Tx is reflected by a target object and then returned to a grating coupler for the transmission signal Tx. Therefore, in order to dislocate a path of the light reflected by a target object to an optical path of the reception signal Rx illustrated in FIG. 8D, optical path separation is required.

Hereinafter, a method of separating an optical path of the transmission signal Tx (hereinafter, transmission light) from an optical path of the reception signal Rx (hereinafter, reception light) is described in detail with reference to FIG. 9A to FIG. 11.

FIG. 9A is a block diagram illustrating a configuration of the LiDAR system 1000 according to one or more embodiments. FIG. 9B is a block diagram illustrating a configuration included in an optical path separator according to one or more embodiments. Description of aspects that are the same as or similar to those described above may be omitted.

Referring to FIG. 2, FIG. 6, and FIG. 9A, the LiDAR system 1000 may include a silicon photonics chip (hereinafter, referred to as a Si-Ph chip) 1100, an optical path separator 1200, and a convex lens 1300.

The Si-Ph chip 1100 according to one or more embodiments may include a signal generator 1110, an optical transmission coupler 1120, an optical reception coupler 1130, an optical coupler 1140, and a photoelectric converter 1150. Here, the signal generator 1110 illustrated in FIG. 9A may correspond to the signal generator 100 of FIG. 2, the optical transmission coupler 1120 and the optical reception coupler 1130 illustrated in FIG. 9A may correspond to a pair of optical antennas 220 of FIG. 6, the optical coupler 1140 illustrated in FIG. 9A may correspond to the second optical coupler 230 of FIG. 6, and the photoelectric converter 1150 illustrated in FIG. 9A may correspond to the photoelectric converter 240 of FIG. 6.

According to one or more embodiments, the LiDAR system 1000 may be an FPA FMCW LiDAR system 1000 implemented with the Si-Ph chip 1100. According to a measurement principle of a FMCW, the signal generator 1110 may generate frequency-modulated light (or transmission light). The transmission signal Tx (or the transmission light) may be emitted to the outside of the Si-Ph chip 1100 through the optical transmission coupler 1120. The optical transmission coupler 1120 may be a grating coupler or an edge coupler. The transmission light emitted to a free space outside the LiDAR system 1000 through the convex lens 1300 may be returned through the convex lens 1300 as the reception signal Rx (or reception light) including information on a target object OBJ. In this case, the optical path separator 1200 changes an optical path of the reception light from an optical path of the transmission light such that the reception light may be returned to the optical coupler 1140 located at a different position from the optical transmission coupler 1120. The reception light may be transmitted to a waveguide through the optical reception coupler 1130. The local oscillator signal LO may be mixed with the reception signal Rx by the optical coupler 1140, and a beating optical signal (or beat light) may be transmitted to the photoelectric converter 1150. The photoelectric converter 1150 may convert beat frequency information into an electrical signal.

Referring to FIG. 9A and FIG. 9B, the optical path separator 1200 may include at least one polarizer 1161 (hereinafter described with reference to multiple polarizers) and a polarization rotator 1162. The multiple polarizers 1161 may have different optical paths depending on polarization, and may be implemented with, for example, a birefringent material. The polarization rotator 1162 may be one of a reciprocal rotator and a non-reciprocal rotator, or a combination thereof. For example, the polarization rotator 1162 may be implemented by a Faraday rotator and a half-wave plate. The optical path separator 1200 may be stacked on the Si-Ph chip 1100.

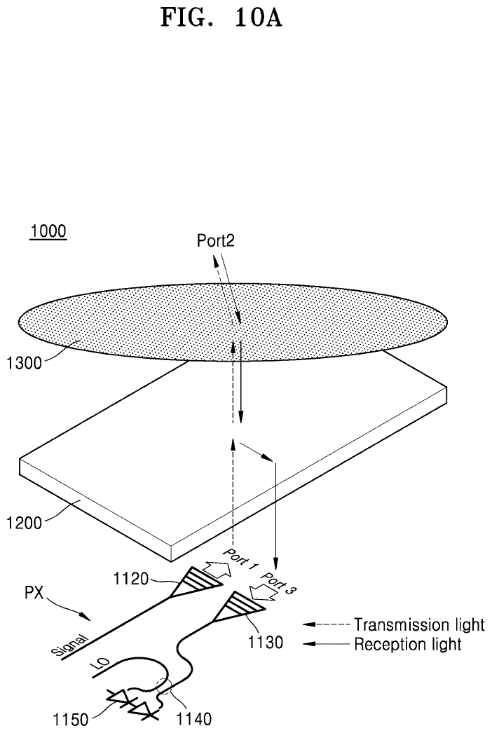

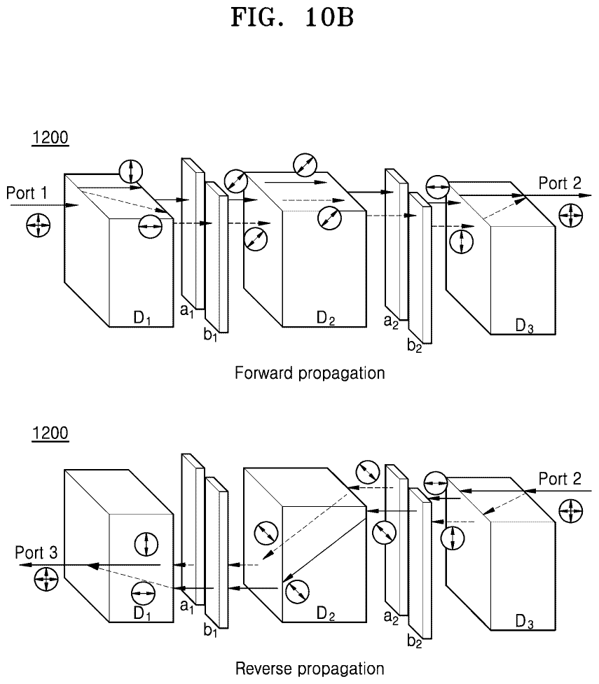

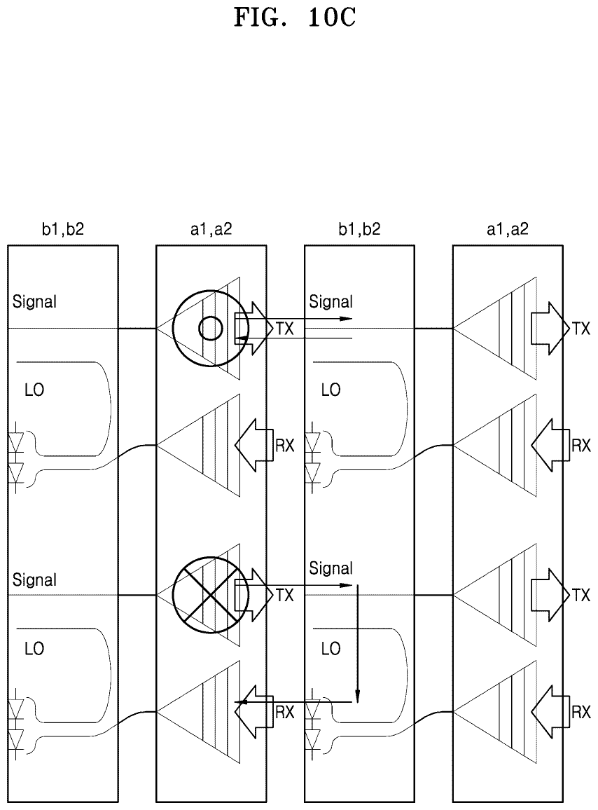

FIG. 10A is a diagram illustrating an optical path separator viewed from a pixel according to one or more embodiments. FIG. 10B is a perspective view illustrating an optical path dislocation of the reception signal Rx by an optical path separator, according to one or more embodiments. FIG. 10C is a diagram illustrating a process of forming the optical path separator illustrated in FIG. 10B according to one or more embodiments.

Referring to FIG. 9A and FIG. 10A, a LiDAR system 1000 according to one or more embodiments may include an optical path separator 1200 between a Si-Ph chip 1100 and a convex lens 1300.

The Si-Ph chip 1100 may include multiple pixels PX. A pixel PX may include an optical transmission coupler 1120 (or a first optical antenna) that emits transmission light into a free space, an optical reception coupler 1130 (or a second optical antenna) that receives reception light from the free space, an optical coupler 1140 that mixes a local oscillator signal LO with the reception light (or the reception signal Rx) to generate an output signal (or bit light), and a photoelectric converter 1150 that converts the output signal into an electrical signal. The photoelectric converter 1150 may include a balanced photodiode that converts an optical signal into an electrical signal and a transimpedance amplifier that amplifies the intensity of the electrical signal.

By arranging the optical path separator 1200 between the Si-Ph chip 1100 and the convex lens 1300, the optical path of the transmission light may be matched to the optical transmission coupler 1120, and the optical path of the reception light may be matched to the optical reception coupler 1130.

Referring to FIG. 10B, the optical path separator 1200 according to one or more embodiments may include a first birefringent plate D1 that divides the light incident on a first port port1 into two lights having orthogonal polarization states during forward propagation and recombines two incident lights at a third port port3 located at a different position from the first port port1 during reverse propagation, a second birefringent plate D2 that allows the incident light to pass therethrough without a spatial change during the forward propagation and allows the incident light to pass therethrough a different path from the path of the forward propagation during the reverse propagation, a third birefringent plate D3 that recombines two incident lights at a second port port2 during the forward propagation and divides the light incident on the second port port2 into two lights having orthogonal polarization states during the reverse propagation, a first Faraday rotator a1 rotating the incident light by +45° and a second Faraday rotator b1 rotating the incident light by −45° which are separated from each other between the first birefringent plate D1 and the second birefringent plate D2, and a third Faraday rotator a2 rotating the incident light by +45° and a fourth Faraday rotator b2 rotating the incident light by −45° which are separated from each other between the second birefringent plate D2 and the third birefringent plate D3. In this case, the first birefringent plate D1, the second birefringent plate D2, and the third birefringent plate D3 may each be formed of a birefringent material, such as YVO4, and the first Faraday rotator a1, the second Faraday rotator b1, the third Faraday rotator a2, and the fourth Faraday rotator b2 may each be a non-reciprocal rotator that rotates the polarization at a preset angle regardless of a direction of propagation of light, which is different from a retarder or a waveplate, and may be formed of a photonic material, such as Bi.

Specifically, during forward propagation, light incident on the first port port1 may be divided into an ordinary ray and an extraordinary ray by the first birefringent plate D1, which are respectively indicated by solid lines and dotted lines in FIG. 10B. Polarization states are illustrated near the respective lights. The two rays may be separated in a horizontal direction after passing through the first birefringent plate D1 and then pass through separate Bi-YIG Faraday rotators. The first Faraday rotator a1 on the left may rotate the ordinary ray by +45°, and the second Faraday rotator b1 on the right may rotate the extraordinary ray by −45°, and spatial positions of the two rays do not change during this process. After passing through a first set of Faraday rotators a1 and b1, the two rays have the same polarization state and exist as ordinary rays in the second birefringent plate D2. Here, the two rays have the same polarization state, thereby passing through the second birefringent plate D2 without additional divergence. In the second set of Faraday rotators a2 and b2, the left ray is additionally rotated by +45° by the third Faraday rotator a2, and the right ray is additionally rotated by −45° by the fourth Faraday rotator b2, and accordingly, polarization states of the two rays may be orthogonal to each other. The third birefringent plate D3 combines the two rays into one ray to reconstruct an input optical signal at the output, but the polarization may be output in a state of being rotated by 90°.

In addition, when the light (or reception light) returned to the second port port2 is propagated in a reverse direction, the ray may pass through the third birefringent plate D3 and be divided. However, due to the irreversible nature, the third Faraday rotator a2 may rotate the reception light by +45°, and the fourth Faraday rotator b2 may rotate the reception light by −45°, and both reception lights may rotate in the same direction as the forward propagated light. After going back and forth through the second set of Faraday rotators a2 and b2, the total polarization rotation may be 90°. Therefore, the light propagated in the reverse direction in the second birefringent plate D2 becomes the same polarization state again, but polarization directions thereof become directions of the extraordinary rays. Due to the polarization rotation, the light propagated in the reverse direction do not follow the same path as the light propagated in the forward direction in the second birefringent plate D2. After passing through the first set of Faraday rotators a1 and b1 and the first birefringent plate D1, the light propagated in the reverse direction may be eventually recombined at an input side of the third port port3, which is at a different spatial position from the first port port1.

The dislocation of the divided optical paths may be proportional to a thickness of the second birefringent plate D2. For example, when the first port port1 is separated by 100 μm from the third port port3 and the second birefringent plate D2 is YVO4, a YVO4 glass with a thickness of about 10 times, that is, 1 mm, may be used.

Referring to FIG. 10C, according to one or more embodiments, a Faraday rotator may be formed on the birefringent plate by patterning. The Faraday rotator may be implemented by forming Bi:YIG as a thin film (for example, through a sputtering process), and then magnetizing the thin film in a multipolar pattern on the cross-section. The arrows illustrated in FIG. 10C indicate an optical path of an extraordinary ray among the transmission light components and an optical path of the extraordinary ray among the reception light components.

For example, the first Faraday rotator a1 and the second Faraday rotator b1 may be patterned on one side of the first birefringent plate D1. After Bi:YIG is formed as a thin film (for example, about 485 um) on one surface of the first birefringent plate D1 (for example, by a sputtering process), the first Faraday rotator a1 rotating the incident light by +45° by applying a magnetic field in a column direction while and the second Faraday rotator b1 rotating the incident light by −45° by applying the magnetic field in the column direction may be formed to be separated from each other in a row direction as illustrated in FIG. 10C.

Also, the third Faraday rotator a2 and the fourth Faraday rotator b2 may be patterned on one surface of the second birefringent plate D2. Likewise, after Bi:YIG is forms as a thin film (for example, about 485 um) on one surface of the second birefringent plate D2 (for example, by a sputtering process), the third Faraday rotator a2 rotating the incident light by +45° by applying a magnetic field in a column direction while and the fourth Faraday rotator b2 rotating the incident light by −45° by applying the magnetic field in the column direction may be formed to be separated from each other in the row direction as illustrated in FIG. 10C.

In addition to the embodiments illustrated in FIG. 10A to FIG. 10C, various optical path separators 1200 may be implemented by, for example, a method of stacking three birefringent materials, a Faraday rotator, and a half-wave plate. The disclosure is not limited to the configurations of the embodiments described above, and the optical path separator 1200 that separates optical paths by utilizing a birefringent material may be arranged between the Si-Ph chip 1100 and the convex lens 1300, and accordingly, an optical path of the transmission signal TX and an optical path of the reception signal RX may be separated from each other in the pixel PX of the FPA LiDAR system 1000.

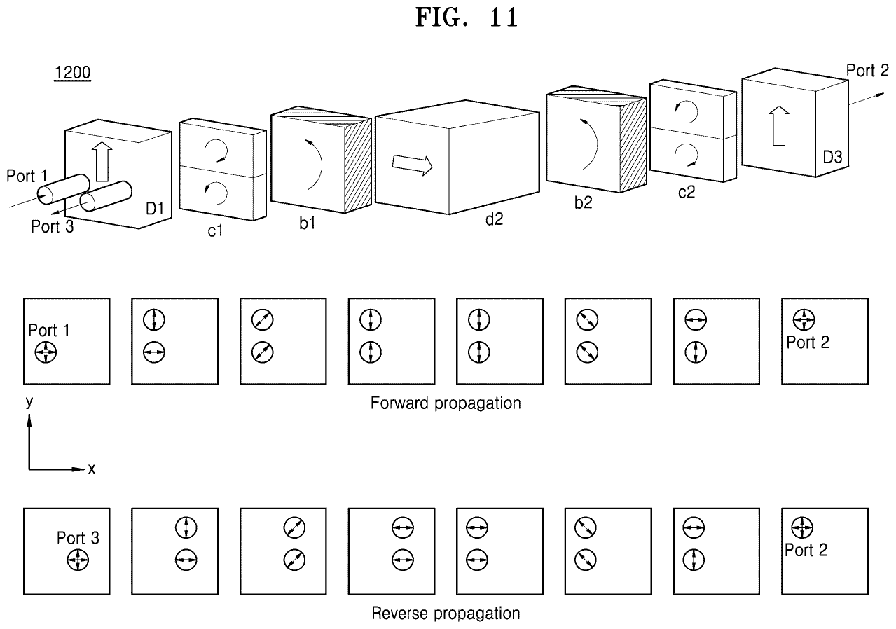

FIG. 11 is a perspective view illustrating the optical path separator 1200 according to one or more embodiments.

Referring to FIG. 9A and FIG. 11, by arranging the optical path separator 1200 between the Si-Ph chip 1100 and the convex lens 1300, an optical path of transmission light may be matched to the optical transmission coupler 1120, and an optical path of reception light may be matched to the optical reception coupler 1130.

Referring to FIG. 11, the optical path separator 1200 according to one or more embodiments includes a first birefringent plate D1 that divides the light incident on a first port port1 into two lights having orthogonal polarization states during forward propagation and recombines two incident lights at a third port port3 located at a different position from the first port port1 during reverse propagation, a second birefringent plate D2 that allows the incident light to pass therethrough without a spatial change during the forward propagation and allows the incident light to pass therethrough a different path from the path of the forward propagation during the reverse propagation, a third birefringent plate D3 that recombines two incident lights at a second port port2 during the forward propagation and divides the light incident on the second port port2 into two lights having orthogonal polarization states during the reverse propagation, a first half-wave plate c1 arranged between the first birefringent plate D1 and the second birefringent plate D2 and having a part (for example, an upper half area) rotating the incident light by +45° and the other part (for example, a lower half area) rotating the incident light by −45°, a second Faraday rotator b1 arranged between the half-wave plate c1 and the second birefringent plate D2 and rotating the incident light by −45°, a fourth Faraday rotator b2 arranged between the second birefringent plate D2 and the third birefringent plate D3 and rotating the incident light by −45°, and a second half-wave plate c2 arranged between the fourth Faraday rotator b2 and the third birefringent plate D3 and having a part (for example, an upper half area) rotating the incident light by −45° and the other part (for example, a lower half area) rotating the incident light by +45°.

Specifically, during forward propagation, the light incident on the first port port1 may be divided into two lights having orthogonal polarization states along a y-axis of the first birefringent plate D1. Thereafter, the two lights sequentially pass through the first half-wave plate c1 and the second Faraday rotator b1. The light incident on an upper half area of the first half-wave plate c1 may rotate by +45°, and the light incident on a lower half area of the first half-wave plate c1 may rotate by −45°, and accordingly, polarization directions of the two lights may be the same. Thereafter, the two lights may be additionally rotated by −45° by the second Faraday rotator b1. Because the two lights have the same polarization state, the two lights may pass through the second birefringent plate D2 without additional divergence. Thereafter, the two lights sequentially pass through the fourth Faraday rotator b2 and the second half-wave plate c2. The two lights may be rotated by −45° by the fourth Faraday rotator b2. The light incident on an upper half area of the second half-wave plate c2 may rotate by −45°, and the light incident on a lower half area of the second half-wave plate c2 may rotate by +45°, and accordingly, polarization states the two lights may be orthogonal to each other. The third birefringent plate D3 combines the two lights into one light and reconstructs an input optical signal at the output, but the polarization may be output in a state of being rotated by 90°.

In addition, when the light (or reception light) returned to the second port port2 is propagated in a reverse direction, the light may pass through the third birefringent plate D3 and be divided. Thereafter, the two lights sequentially pass through the second half-wave plate c2 and the fourth Faraday rotator b2. The light incident on an upper half area of the second half-wave plate c2 may rotate by +45°, and the light incident on a lower half area of the second half-wave plate c2 may rotate by −45°, and accordingly, polarization directions of the two lights may be the same. Thereafter, the two lights may be additionally rotated by −45° by the fourth Faraday rotator b2.

Because directions of the two lights coincide with an optical direction of the crystal of the second birefringent plate D2, the two lights may move spatially along an x axis. Thereafter, the two lights sequentially pass through the second Faraday rotator b1 and the first half-wave plate c1. The two lights may be rotated by −45° by the second Faraday rotator b1. The light incident on an upper half area of the first half-wave plate c1 may rotate by −45°, and the light incident on a lower half area of the first half-wave plate c1 may rotate by +45°, and accordingly polarization states the lights may be orthogonal to each other. The light passing through the first birefringent plate D1 and propagating in a reverse direction is eventually recombined at an input side of the third port port3, which is at a different spatial position from the first port port1.

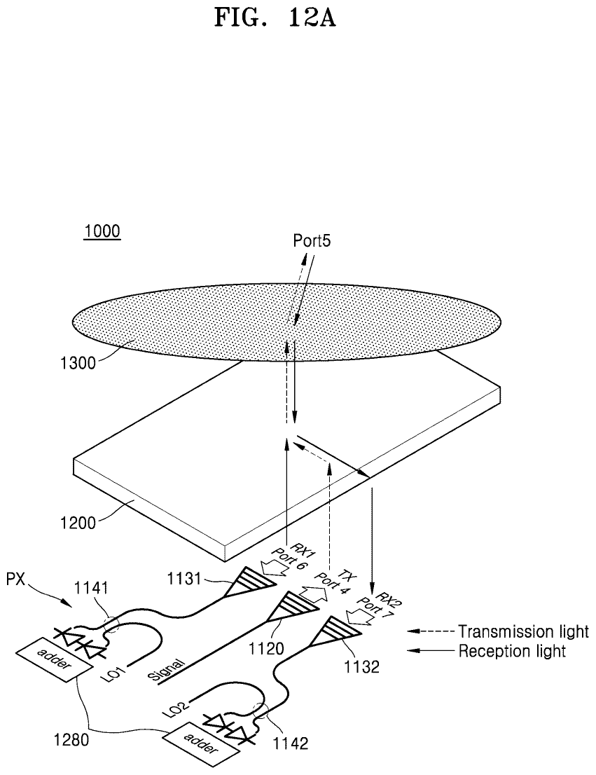

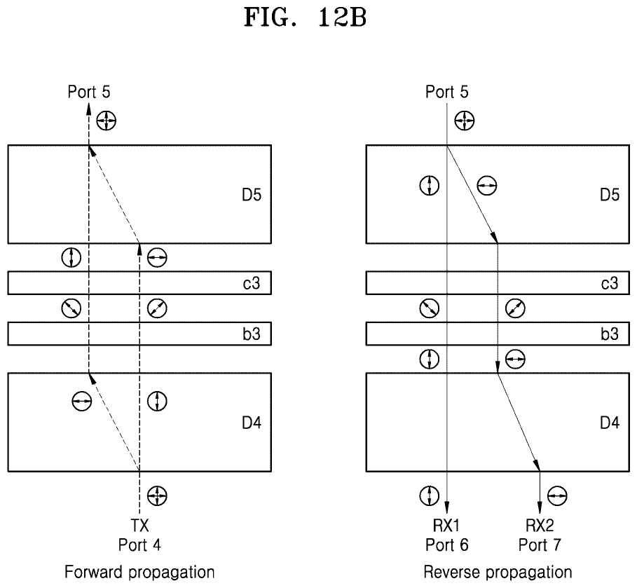

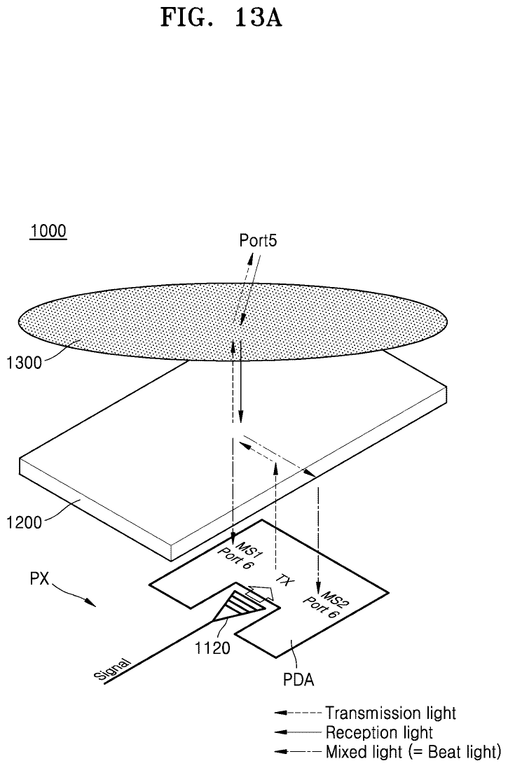

FIG. 12A is a diagram illustrating an optical path separator according to one or more embodiments viewed from a pixel. FIG. 12B is a perspective view illustrating an optical path dislocation of the reception signal Rx caused by the optical path separator of FIG. 12A according to one or more embodiments.

Referring to FIGS. 9A and 12A, the LiDAR system 1000 according to one or more embodiments may include the optical path separator 1200 provided between the Si-Ph chip 1100 and the convex lens 1300.

The Si-Ph chip 1100 may include multiple pixels PX. A pixel PX may include an optical transmission coupler 1120 (or a third optical antenna) that emits transmission light into a free space, a first optical reception coupler 1131 (or a fourth optical antenna) and a second optical reception coupler 1132 (or a fifth optical antenna) that receive reception lights from the free space and are separated from each other, a first optical coupler 1141 that mixes a first local oscillator signal LO1 with a first reception light (or a first reception signal RX1) to generate a first output signal (or a bit light), a second optical coupler 1142 that mixes a second local oscillator signal LO2 with a second reception light (or a second reception signal RX2) to generate a second output signal (or a bit light), and a photoelectric converter 1150 that converts the first and second output signals into electrical signals. The photoelectric converter 1150 may include a balanced photodiode that converts an optical signal into an electrical signal and a transimpedance amplifier that amplifies the intensity of the electrical signal.

By arranging the optical path separator 1200 between the Si-Ph chip 1100 and the convex lens 1300, a transmission optical path may be matched to the optical transmission coupler 1120, and a reception optical path may be matched to the first optical reception coupler 1131 and the second optical reception coupler 1132.

Referring to FIG. 12B, an optical path separator 1200 according to one or more embodiments may include a fourth birefringent plate D4 that divides the light incident on a fourth port port4 into two lights having orthogonal polarization states during forward propagation and allows incident light to pass through a sixth port port6 and a seventh port port7 located at different positions from the fourth port port4 during reverse propagation, a fifth birefringent plate D5 that recombines two incident lights at a fifth port port5 during forward propagation and divides the light incident on the fifth port port5 into two lights having orthogonal polarization states during reverse propagation, a fifth Faraday rotator b3 arranged between the fourth birefringent plate D4 and the fifth birefringent plate D5 and rotates the incident light by +45° during forward propagation and reverse propagation, and a half-wave plate c3 arranged between the fifth Faraday rotator b3 and the fifth birefringent plate D5 and rotating the incident light by +45° during forward propagation and rotating the incident light by −45° during reverse propagation.

In this case, the fourth birefringent plate D4 and the fifth birefringent plate D5 may each be formed of a birefringent material, such as YVO4, and the fifth Faraday rotator b3 may be a non-reciprocal rotator that rotates the polarization at a preset angle regardless of a direction of propagation of light, which is different from a retarder or a waveplate, and may be formed of a photonic material, such as Bi. The waveplate is an element of which vibration direction is controlled by an optical system, and changes the polarization of light by delaying a phase. For example, when the incident light is a p-polarized wave (or a horizontally polarized TM wave), the light passing through the half-wave plate c3 changes to an s-polarized wave (or a vertically polarized TE wave). The waveplate is a reciprocal rotator, and a polarized wave of the waveplate rotates differently depending on propagation directions of lights.

Specifically, during forward propagation, the light incident on the fourth port port4 may be divided into an ordinary ray and an extraordinary ray by the first fourth birefringent plate D4. Polarization states are illustrated near the respective rays. The two lights are separated in a horizontal direction after passing through the fourth birefringent plate D4 and pass through the fifth Faraday rotator b3 that is a separate Bi-YIG. The fifth Faraday rotator b3 may rotate the ordinary ray and the extraordinary ray by +45°. Thereafter, the two lights are additionally rotated by +45° by the half-wave plate c3, and accordingly, polarization states of the two lights may be orthogonal to each other. The fifth birefringent plate D5 combines the two lights into one light to reconstruct an input light signal at an output, but the one light may be output after rotating by 90°.

In addition, when the light (or reception light) returned to the fifth port port5 propagates in the reverse direction, the light may pass through the fifth birefringent plate D5 and be divided. Thereafter, the two lights sequentially pass through the half-wave plate c3 and the fifth Faraday rotator b3. The light incident on the half-wave plate c3 may rotate by −45° and may be additionally rotated by +45° by the fifth Faraday rotator b3. Thereafter, the lights passing through the fourth birefringent plate D4 to be transmitted in the reverse direction may be separately incident on the sixth port port6 and the seventh port port7 on both sides of the fourth port port4, and by aligning the first optical reception coupler 1131 and the second optical reception coupler 1132 respectively in the sixth port port6 and the seventh port (port7, optical loss may be reduced. In this case, among the returned reception lights (or the reception signals Rx), a first reception signal RX1 and a second reception signal RX2 are returned with different polarizations, and accordingly, it is preferable to provide a grating coupler, waveguide, and a local oscillator signal optimized for the reception signals, and bit signals (or bit lights) of the first reception signal RX1 and the second reception signal RX2 may be converted into balanced photodiode signals (for example, a first output signal and a second output signal) and then summed. According to one or more embodiments, each of the pixels PX may include an adder 1280 that synthesizes the first output signal and the second output signal converted into electrical signals.

In addition, the LiDAR system 1000 may perform data analysis by using the first output signal and the second output signal without summing the first output signal and the second output signal. A polarization state changes depending on a surface state, a material, a structure, and surface roughness of a target object, and accordingly, additional detailed information, which may not be obtained from a single polarization signal, may be obtained by analyzing different polarization states.

For example, polarization information may provide the following additional information: Because different materials reflect incident light in different ways, the material of a target object may be identified therethrough. Also, by analyzing the polarization of a reflected signal, whether the surface of a target object is smooth, rough, or wet may be determined. Also, because a change in polarization of the light reflected from the surface of a target object helps in estimating a geometric orientation or inclination of the target object, a direction and so on of the target object may be identified.

The embodiments described with reference to FIG. 12A and FIG. 12B may each have a simplified configuration with a smaller number of optical components (for example, a birefringent plate, a half-wave plate, a Faraday rotator, and so on) compared to the embodiments described with reference to FIG. 10B and FIG. 11, and thus, the yield of a production process of the LiDAR system 1000 may be efficiently managed, and production costs thereof may be reduced.

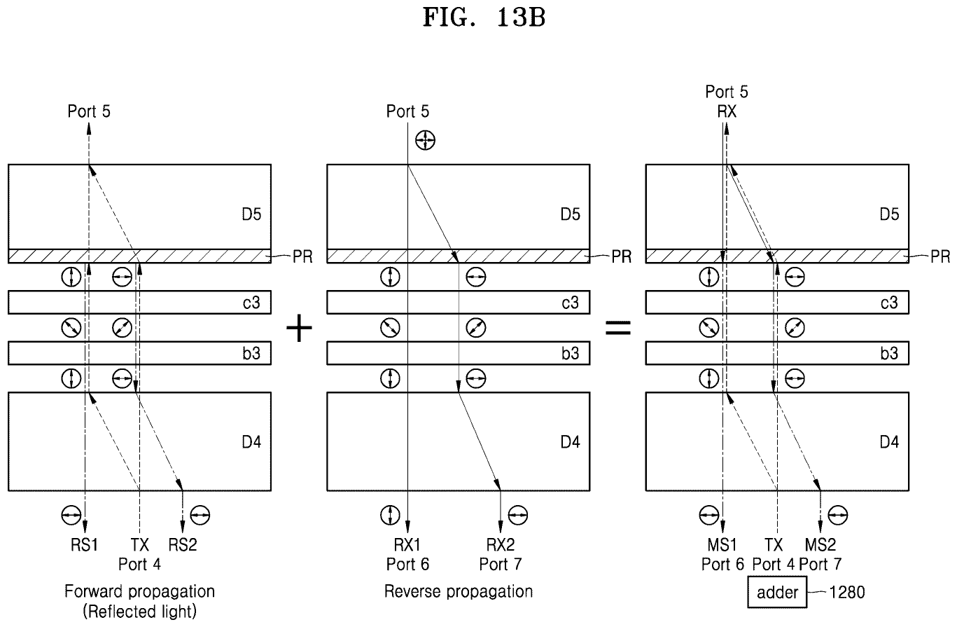

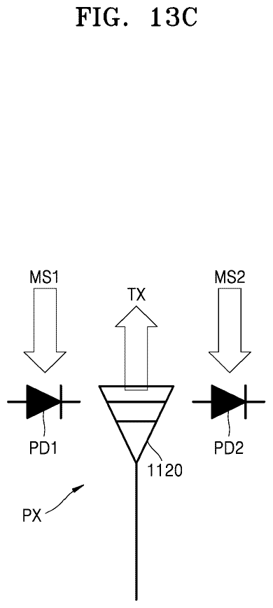

FIG. 13A is a diagram illustrating an optical path separator according to one or more embodiments viewed from a pixel. FIG. 13B is a perspective view illustrating a partial reflective surface included in the optical path separator of FIG. 13A according to one or more embodiments. FIG. 13C is a diagram illustrating a photodiode of FIG. 13A according to one or more embodiments.

Embodiments illustrated in FIG. 13A to FIG. 13C differ from the embodiments illustrated in FIG. 12A and FIG. 12B in that a partial reflection surface PR is formed on one surface of the optical path separator 1200 (or a fifth birefringent plate D5) and the optical reception coupler 1130 and the optical coupler 1140 are omitted, and the other configurations are substantially the same. Hereinafter, redundant descriptions thereof may be omitted, and differences therebetween are mainly described.

Referring to FIG. 9A and FIG. 13A, a LiDAR system 1000 according to one or more embodiments may include an optical path separator 1200 between a Si-Ph chip 1100 and a convex lens 1300.

The Si-Ph chip 1100 may include multiple pixels PX. The multiple pixels PX may each include an optical transmission coupler 1120 (or a sixth optical antenna) that emits transmission light (or a transmission signal Tx) to a free space, and a photoelectric converter 1150 including a photodiode area PDA that converts a first mixed light MS1 generated by mixing a first reception light RX1 with a first reflection light RS1 and a second mixed light MS2 generated by mixing a second reception light RX2 with a second reflection light RS2 into electrical signals.

When the optical path separator 1200 (or the fifth birefringent plate D5) includes the partial reflection surface PR, the light reflected by the partial reflection surface PR and the reception light reflected from a target object may be mixed together in a free space. Due to this, among the components of the LiDAR system 1000 illustrated in FIG. 9A, components required to mix the reception light with a local oscillator signal (for example, the optical reception coupler 1130 and the optical coupler 1140) may be omitted.

Referring to FIG. 13B, an optical path separator 1200 according to one or more embodiments may include a fourth birefringent plate D4 that divides the light incident on a fourth port port4 into two lights having orthogonal polarization states during forward propagation and allows incident light to pass through a sixth port port6 and a seventh port port7 located at different positions from the fourth port port4 during reverse propagation, a fifth birefringent plate D5 that recombines two incident lights at a fifth port port5 during forward propagation and divides the light incident on the fifth port port5 into two lights having orthogonal polarization states during reverse propagation, a fifth Faraday rotator b3 arranged between the fourth birefringent plate D4 and the fifth birefringent plate D5 and rotates the incident light by +45° during forward propagation and reverse propagation, and a half-wave plate c3 arranged between the fifth Faraday rotator b3 and the fifth birefringent plate D5 and rotating the incident light by +45° during forward propagation and rotating the incident light by −45° during reverse propagation. The partial reflection surface PR may be formed by applying a partial reflection material on one surface of the fifth birefringent plate D5 which faces the half-wave plate c3. The partial reflection material refers to a material that reflects some of lights and transmits the other lights therethrough. The partial reflection surface PR may preferably have a transmittance greater than a reflectance.

In this case, the fourth birefringent plate D4 and the fifth birefringent plate D5 may each be formed of a birefringent material, such as YVO4, and the fifth Faraday rotator b3 may be a non-reciprocal rotator that rotates the polarization at a preset angle regardless of a direction of propagation of light, which is different from a retarder or a waveplate, and may be formed of a photonic material, such as Bi. The waveplate is an element of which vibration direction is controlled by an optical system, and changes the polarization of light by delaying a phase. For example, when the incident light is a p-polarized wave (or a horizontally polarized TM wave), the light passing through the half-wave plate c3 changes to an s-polarized wave (or a vertically polarized TE wave). The waveplate is a reciprocal rotator, and a polarized wave of the waveplate rotates differently depending on propagation directions of lights.

Specifically, during forward propagation, the light incident on the fourth port port4 may be divided into an ordinary ray and an extraordinary ray by the first fourth birefringent plate D4. Polarization states are illustrated near the respective rays. The two lights are separated in a horizontal direction after passing through the fourth birefringent plate D4 and pass through the fifth Faraday rotator b3 that is a separate Bi-YIG. The fifth Faraday rotator b3 may rotate the ordinary ray and the extraordinary ray by +45°. Thereafter, the two lights are additionally rotated by +45° by the half-wave plate c3, and accordingly, polarization states of the two lights may be orthogonal to each other.

Thereafter, some of the two lights may be reflected by the partial reflection surface PR included in the fifth birefringent plate D5, and the other of the two lights may transmit through the partial reflection surface PR. The light reflected by the partial reflection surface PR may be incident perpendicularly on the partial reflection surface PR, be reflected, and maintain a previous polarization state. Therefore, polarization states of the two lights may be orthogonal to each other. Thereafter, the two lights sequentially pass through the half-wave plate c3 and the fifth Faraday rotator b3. The light incident on the half-wave plate c3 may rotate by −45° and may be further rotated by +45° by the fifth Faraday rotator b3.

That is, polarization states of reflected lights RS1 and RS2 may be the same as the polarization states of the lights (or the reception lights RX1 and RX2) that returns to the fifth port port5 during reverse propagation, and optical paths of the reflected lights RS1 and RS2 may match the reception lights RX1 and RX2. Due to this, the first reflected light RS1 and the first reception light RX1 may be mixed together in a free space to form the first mixed light MS1 (or the first bit light). Likewise, the second reflected light RS2 and the second reception light RX2 may be mixed together in a free space to form the second mixed light MS2 (or the second bit light). That is, the reflected lights RS1 and RS2 may perform substantially the same function as the local oscillator signal LO.

In this case, the partial reflection surface PR may be formed not only on one surface of the fifth birefringent plate D5, but also on one surface of the fifth Faraday rotator b3 or one surface of the half-wave plate c3, and thus, the same effect may be obtained. That is, the light incident on one surface of the fifth Faraday rotator b3 or one surface of the half-wave plate c3 may be incident perpendicularly on the partial reflection surface PR and reflected, and accordingly, a previous polarization state may be maintained.

As described above, the reception lights RX1 and RX2 may be respectively mixed with the reflected lights RS1 and RS2 to be the mixed light rays MS1 and MS2, and accordingly, the optical reception coupler (1130 in FIG. 9A) that causes the reception lights RX1 and RX2 to be incident on a waveguide, and the optical coupler 1140 that mixes the reception lights RX1 and RX2 with the local oscillator signal LO may be omitted, and the photoelectric converter 1150 may directly receive the mixed lights MS1 and MS2 and convert the mixed lights MS1 and MS2 into electrical signals.

Although FIG. 13A illustrates that the photodiode area PDA receives the mixed lights MS1 and MS2 to increase the power efficiency of the photoelectric converter 1150, the disclosure is not limited thereto. For example, as illustrated in FIG. 13C, each of the pixels PX may also include an optical transmission coupler 1120 (or a sixth optical antenna) that emits a transmission light (or a transmission signal Tx) to a free space, and a photoelectric converter 1150 including a first photodiode PD1 that converts the first mixed light MS1 generated by mixing the first reflected light RS1 with the first reception light RX1 into an electrical signal, and a second photodiode PD2 that converts the second mixed light MS2 generated by mixing the second reception light RX2 with the second reflected light RS2 into an electric signal. In this case, each of the pixels PX may include an adder 1380 that synthesizes the first mixed light MS1 and the second mixed light MS2 converted into electrical signals.

In addition, the LiDAR system 1000 may analyze data by using the first mixed light MS1 and the second mixed light MS2 without synthesizing the first mixed light MS1 and the second mixed light MS2. A polarization state changes depending on a surface state, a material, a structure, and surface roughness of a target object, and accordingly, additional detailed information, which may not be obtained from a single polarization signal, may be obtained by analyzing different polarization states.

Polarization information may provide additional information. For example, because different materials reflect incident light in different ways, the material of a target object may be identified therethrough. Also, by analyzing the polarization of a reflected signal, whether the surface of a target object is smooth, rough, or wet may be determined. Also, because a change in polarization of the light reflected from the surface of a target object helps in estimating a geometric orientation or inclination of the target object, a direction and so on of the target object may be identified.

In addition, the transmission light (or the transmission signal Tx) may have substantially equal ratios of vertical polarization components and horizontal polarization components to increase the power efficiency of the photoelectric converter 1150. Because the reception light (or the reception signal Rx) is light that is reflected by the target object and returned, the reception light may have both the horizontal polarization component and the vertical polarization component. That is, when the transmission light (or the transmission signal Tx) has only one polarization component among the vertical polarization component and the horizontal polarization component, the reflected light RS also has only one polarization component among the vertical polarization component and the horizontal polarization component, and accordingly, some of the reception lights (or the reception signals Rx) may not be mixed in a free space.

For example, when the optical transmission coupler 1120 has only one of the vertical polarization component and the horizontal polarization component, and when an angle formed by the Si-Ph chip 1100 and the optical path separator 1200 is about 45°, the transmission light (or the transmission signal Tx) may have substantially equal ratios of the vertical polarization component and the horizontal polarization component. However, the method for preventing the polarization components of the transmission light from being single is not limited thereto, and various methods of generating and combining respective polarization components may be applied.

The embodiments described with reference to FIG. 13A to FIG. 13C may each have a simplified configuration with a smaller number of components (for example, an optical reception coupler and an optical coupler) of a Si-Ph chip compared to the embodiments described with reference to FIG. 12A and FIG. 12B, and thus, a production process of the LiDAR system 1000 may be simplified, and production costs thereof may be reduced.

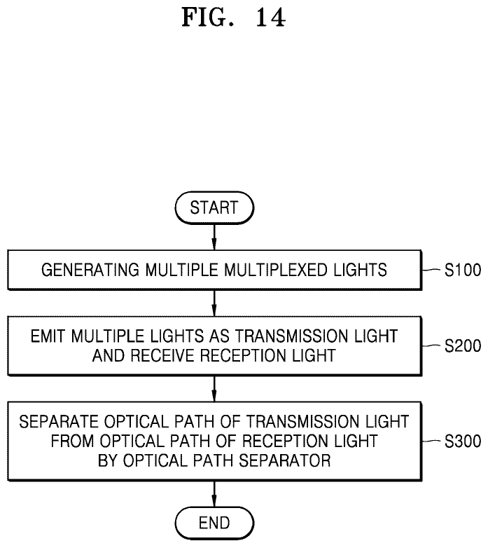

FIG. 14 is a flowchart illustrating an operating method of a LiDAR system, according to one or more embodiments. Here, even when the configurations described with reference to FIG. 1 to FIG. 13C are not explicitly described in FIG. 14, the configurations may be applied to one or more embodiments described with reference to FIG. 14.

Referring to FIG. 1 to FIG. 14, an operating method of the LiDAR system 1000, according to one or more embodiments, includes operation S100 of generating multiple lights having different wavelengths by the signal generator 1110, operation S200 of emitting multiple lights as transmission lights (or, the transmission signals TX) from the transceiver 200 and receiving reception lights (or, the reception signals RX) obtained by reflection of the transmission lights (or, the transmission signals TX) from the target object OBJ, and operation S300 of separating an optical path of the transmission light (or, the transmission signal TX) from an optical path of the reception light (or, the reception signal RX) by the optical path separator 1200 included in the transceiver 200.

The transceiver 200 may include the focal plane array FPA in which the multiple pixels PX are arranged in a matrix, and each of the pixels PX may include the optical transmission coupler 1120 (or a sixth optical antenna) that emits transmission light into a free space, and the photoelectric converter 1150 including the photodiode area PDA that converts the first mixed light MS1 generated by mixing the reception light with the first reflected light RS1, and the second mixed light MS2 generated by mixing the reception light with the second reflected light RS2 into electrical signals.

An optical path separator 1200 according to one or more embodiments may include a fourth birefringent plate D4 that divides the light incident on a fourth port port4 into two lights having orthogonal polarization states during forward propagation and allows incident light to pass through a sixth port port6 and a seventh port port7 located at different positions from the fourth port port4 during reverse propagation, a fifth birefringent plate D5 that recombines two incident lights at a fifth port port5 during forward propagation and divides the light incident on the fifth port port5 into two lights having orthogonal polarization states during reverse propagation, a fifth Faraday rotator b3 arranged between the fourth birefringent plate D4 and the fifth birefringent plate D5 and rotates the incident light by +45° during forward propagation and reverse propagation, and a half-wave plate c3 arranged between the fifth Faraday rotator b3 and the fifth birefringent plate D5 and rotating the incident light by +45° during forward propagation and rotating the incident light by −45° during reverse propagation. A partial reflection surface PR may be formed on a surface of the fifth birefringent plate D5 which faces the half-wave plate c3.

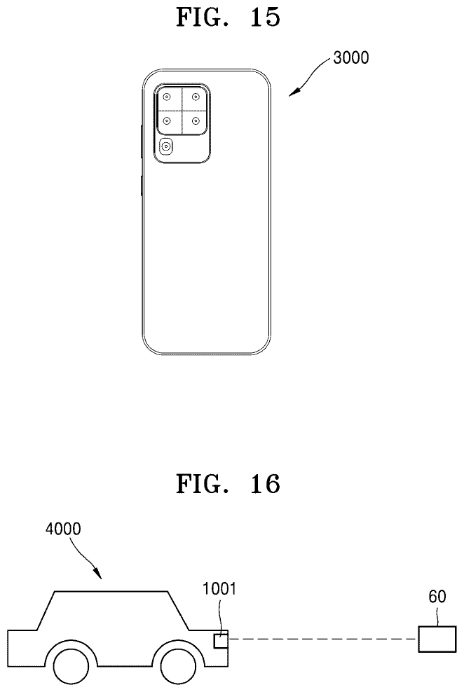

FIG. 15 is a perspective view illustrating an example of an electronic device to which a LiDAR system according to one or more embodiments is applied.

Although FIG. 15 illustrates a form of a mobile phone or a smartphone 3000, an electronic device to which the LiDAR system 1000 is applied is not limited thereto. For example, the LiDAR system 1000 may be applied to a tablet, a smart tablet, a laptop computer, a television, a smart television, or so on.

Also, the LiDAR system according to one or more embodiments may be applied to an autonomous driving device.

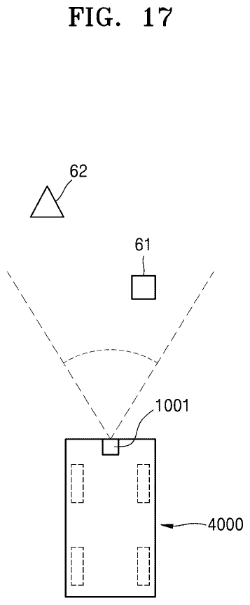

FIG. 16 and FIG. 17 are respectively a side view and a plan view illustrating cases where a LiDAR system according to one or more embodiments is applied to a vehicle.

Referring to FIG. 16, a LiDAR system 1001 may be applied to a vehicle 4000, and information on a subject 60 may be obtained by the vehicle 4000. The LiDAR system described with reference to FIG. 2 to FIG. 8 may be used as the LiDAR system 1001. The LiDAR system 1001 may use a time-of-flight (TOF) method to obtain information on the subject 60. The vehicle 4000 may have an autonomous driving function. As illustrated in FIG. 16, the LiDAR system 1001 may divide a target area of a target field of view into multiple sub-areas and emits a set of beams at a predetermined time interval respectively to the multiple sub-areas. When there is the subject 60 in the target area and the light reflected from the subject 60 is detected, a digital scan of the target area may be started to analyze information on the subject 60. The LiDAR system 1001 may detect a target object or person, that is, the subject 60, in a direction in which the vehicle 4000 moves and may measure a distance to the subject 60 by using information, such as a time difference between a transmitted signal and a received signal. Also, as illustrated in FIG. 17, information on a nearby subject 61 and a distant subject 62 in the target area may be obtained.

Although FIG. 16 and FIG. 17 illustrate that a LiDAR system is applied to a vehicle, the disclosure is not limited thereto. The LiDAR system may be applied to aircrafts such as drones, mobile devices, small walking devices (for example, bicycles, motorcycles, baby strollers, boards, or so on), robots, human/animal assistance devices (for example, canes, helmets, accessories, clothing, watches, bags, or so on), internet of things (IoT) devices/systems, security devices/systems, or so on.

The LiDAR system described above is described with reference to the embodiments illustrated in the drawings, but the embodiments are merely examples, and those skilled in the related art will understand that various modifications and equivalent other embodiments may be derived therefrom. Therefore, the embodiments should be considered from an illustrative viewpoint rather than a limiting viewpoint. The scope of the disclosure is indicated by the claims, not the descriptions made above, and all differences within the scope equivalent thereto should be interpreted as being included in the embodiments.

In a LiDAR system and an operating method thereof according to one or more embodiments, the optical efficiency may be improved by spatially separating an optical path of the transmission light from an optical path of the reception light by an optical path separator.

Each of the embodiments provided in the above description is not excluded from being associated with one or more features of another example or one or more embodiments also provided herein or not provided herein but consistent with the disclosure.

Effects of the embodiments are not limited to the effects described above, and effects not described may be clearly understood by a person having ordinary skill in the art to which the embodiments belong from the embodiments and the attached drawings.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A light-detection and ranging (LiDAR) system comprising:
a signal generator configured to generate a plurality of lights each having a different wavelength from each other;
a transceiver comprising a transmitter configured to emit the plurality of lights as a transmission light and a receiver configured to receive a reception light obtained by reflection of the transmission light from a target object;
an optical path separator in the transceiver and configured to separate an optical path of the transmission light from an optical path of the reception light; and
a convex lens in the optical path separator.

2. The LiDAR system of claim 1, wherein the signal generator comprises:
a light source configured to generate the plurality of lights;
a multiplexer configured to simultaneously receive and multiplex the plurality of lights; and
an optical modulator configured to modulate the plurality of lights.

3. The LiDAR system of claim 1, wherein the transmitter is further configured to emit the transmission light with a plurality of pixels.

4. The LiDAR system of claim 3, wherein the transceiver comprises a focal plane array in which the plurality of pixels are arranged in a matrix.

5. The LiDAR system of claim 4, wherein each pixel of the plurality of pixels comprises:
a first optical antenna configured to emit the transmission light into a free space;
a second optical antenna configured to receive the reception light from the free space;
an optical coupler configured to generate an output signal by mixing a local oscillator signal and the reception light; and
a photoelectric converter configured to convert the output signal into a first electrical signal.

6. The LiDAR system of claim 5, wherein the photoelectric converter comprises a balanced photodiode configured to convert an optical signal into a second electrical signal and a transimpedance amplifier configured to amplify an intensity of the second electrical signal.

7. The LiDAR system of claim 5, wherein the optical path separator comprises:
a first birefringent plate configured to divide light incident on a first port into two lights having orthogonal polarization states during forward propagation and recombine, during reverse propagation, two incident lights at a third port that is located at a different position from the first port;
a second birefringent plate configured to allow first incident light to pass through the second birefringent plate without a spatial change during the forward propagation and allow the first incident light to pass through a second path that is different from a first path of the forward propagation during the reverse propagation;
a third birefringent plate configured to recombine two incident lights at a second port during the forward propagation and divide light incident on the second port into two lights having orthogonal polarization states during the reverse propagation;
a first Faraday rotator configured to rotate second incident light by +45° and a second Faraday rotator configured to rotate third incident light by −45°, wherein the second incident light and the third incident light are separated from each other between the first birefringent plate and the second birefringent plate; and
a third Faraday rotator configured to rotate fourth incident light by +45° and a fourth Faraday rotator configured to rotate fifth incident light by −45°, wherein the fourth incident light and the fifth incident light are separated from each other between the second birefringent plate and the third birefringent plate.

8. The LiDAR system of claim 7, wherein a distance between the first port and the third port is proportional to a thickness of the second birefringent plate.

9. The LiDAR system of claim 4, wherein each pixel of the plurality of pixels comprises:
a third optical antenna configured to emit the transmission light into a free space;
a fourth optical antenna and a fifth optical antenna separated from each other and configured to receive the reception light from the free space;
a first optical coupler configured to generate a first output signal by mixing a first local oscillator signal with first reception light in the reception light;
a second optical coupler configured to generate a second output signal by mixing a second local oscillator signal with second reception light in the reception light; and
a photoelectric converter configured to convert the first output signal and the second output signal into electrical signals.

10. The LiDAR system of claim 9, wherein the optical path separator comprises:
a fourth birefringent plate configured to divide light incident on a fourth port into two lights having orthogonal polarization states during forward propagation and allow, during reverse propagation, incident light to pass through a sixth port and a seventh port that are located at different positions from the fourth port;
a fifth birefringent plate configured to recombine two incident lights at a fifth port during the forward propagation and divide light incident on the fifth port into two lights having orthogonal polarization states during the reverse propagation;
a fifth Faraday rotator between the fourth birefringent plate and the fifth birefringent plate, the fifth Faraday rotator configured to rotate first incident light by +45° during the forward propagation and the reverse propagation; and
a half-wave plate between the fifth Faraday rotator and the fifth birefringent plate, the half-wave plate configured to rotate second incident light by +45° during the forward propagation and rotate the second incident light by −45° during the reverse propagation.

11. The LiDAR system of claim 9, wherein each pixel of the plurality of pixels comprises an adder configured to synthesize the first output signal and the second output signal converted into the electrical signals.

12. The LiDAR system of claim 4, wherein each pixel of the plurality of pixels comprises:
a sixth optical antenna configured to emit the transmission light into a free space;
a first optical diode configured to convert first mixed light generated by mixing the reception light with first reflected light into a first electrical signal; and
a second optical diode configured to convert second mixed light generated by mixing the reception light with second reflected light into a second electrical signal.

13. The LiDAR system of claim 12, wherein the optical path separator further comprises:
a fourth birefringent plate configured to divide light incident on a fourth port into two lights having orthogonal polarization states during forward propagation and allow, during reverse propagation, incident light to pass through a sixth port and a seventh port that are located at different positions from the fourth port;
a fifth birefringent plate configured to recombine two incident lights at a fifth port during the forward propagation and divide light incident on the fifth port into two lights having orthogonal polarization states during the reverse propagation;
a fifth Faraday rotator between the fourth birefringent plate and the fifth birefringent plate, the fifth Faraday rotator configured to rotate first incident light by +45° during the forward propagation and the reverse propagation; and
a half-wave plate between the fifth Faraday rotator and the fifth birefringent plate, the half-wave plate configured to rotate second incident light by +45° during the forward propagation and rotate the second incident light by −45° during the reverse propagation, and
wherein a surface of the fifth birefringent plate which faces the half-wave plate comprises a partial reflection surface.

14. The LiDAR system of claim 12, wherein each pixel of the plurality of pixels further comprises an adder configured to synthesize the first output signal and the second output signal that are converted into the first electrical signal and the second electrical signal, respectively.

15. The LiDAR system of claim 12, wherein the transmission light has substantially equal ratios of a vertical polarization component and a horizontal polarization component.

16. The LiDAR system of claim 4, wherein each pixel of the plurality of pixels further comprises:
a sixth optical antenna configured to emit the transmission light into a free space; and
a photoelectric converter comprising a photodiode area configured to convert, into electrical signals, first mixed light generated by mixing the reception light with first reflected light, and second mixed light generated by mixing the reception light with second reflected light.

17. The LiDAR system of claim 16, wherein the optical path separator comprises:
a fourth birefringent plate configured to divide light incident on a fourth port into two lights having orthogonal polarization states during forward propagation and allow, during reverse propagation, incident light to pass through a sixth port and a seventh port that are located at different positions from the fourth port;
a fifth birefringent plate configured to recombine two incident lights at a fifth port during the forward propagation and divide light incident on the fifth port into two lights having orthogonal polarization states during the reverse propagation;
a fifth Faraday rotator between the fourth birefringent plate and the fifth birefringent plate, the fifth Faraday rotator configured to rotate first incident light by +45° during the forward propagation and the reverse propagation; and
a half-wave plate between the fifth Faraday rotator and the fifth birefringent plate, the half-wave plate configured to rotate second incident light by +45° during the forward propagation and rotate the second incident light by −45° during the reverse propagation, and
wherein a surface of the fifth birefringent plate which faces the half-wave plate comprises a partial reflection surface.

18. An operating method of a light detection and ranging (LiDAR) system, the operating method comprising:
generating, by a signal generator, a plurality of lights each having a different wavelength from each other;
emitting, by a transceiver, the plurality of lights as transmission light and receiving reception light obtained by reflection of the transmission light from a target object; and
separating an optical path of the transmission light from an optical path of the reception light by an optical path separator in the transceiver.

19. The operating method of claim 18, wherein the transceiver comprises a focal plane array in which a plurality of pixels are arranged in a matrix, and
wherein each pixel of the plurality of pixels comprises:
an optical antenna configured to emit the transmission light into a free space, and
a photoelectric converter comprising a photodiode area configured to convert, into electrical signals, first mixed light generated by mixing the reception light with first reflected light, and second mixed light generated by mixing the reception light with second reflected light.

20. The operating method of claim 19, wherein the optical path separator comprises:
a first birefringent plate configured to divide light incident on a first port into two lights having orthogonal polarization states during forward propagation and allow, during reverse propagation, incident light to pass through a third port and a fourth port that are located at different positions from the first port;
a second birefringent plate configured to recombine two incident lights at a second port during the forward propagation and divide light incident on the second port into two lights having orthogonal polarization states during the reverse propagation;
a first Faraday rotator arranged the first birefringent plate and the second birefringent plate, the first Faraday rotator configured to rotate first incident light by +45° during the forward propagation and the reverse propagation; and
a half-wave plate between the first Faraday rotator and the second birefringent plate, the half-wave plate configured to rotate second incident light by +45° during the forward propagation and rotate the second incident light by −45° during the reverse propagation, and
wherein a surface of the second birefringent plate which faces the half-wave plate comprises a partial reflection surface.
